(19) United States
(12) Patent Application Publication
(10) Pub. No.: US 2025/0323698 A1
(43) Pub. Date: Oct. 16, 2025

(54) SINGLE ANTENNA PANEL CODEBOOK

(71) Applicant: QUALCOMM Incorporated, San Diego, CA (US)

(72) Inventors: Shahrukh Khan KASI, San Diego, CA (US); Yi HUANG, San Diego, CA (US)

(21) Appl. No.: 18/634,600

(22) Filed: Apr. 12, 2024

(51) Int. Cl. H04B 7/06

(52) U.S. Cl. CPC H04B 7/0626; H04B 7/063

(57) ABSTRACT

Methods, systems, and devices for wireless communications are described. A user equipment (UE) may support codebook-based signaling in order to perform accurate beam selection and reliable communications as device capabilities advance. The UE may receive, from a network entity, a set of channel state information reference signals (CSI-RSs) associated with a plurality of CSI-RS antenna ports located at the network entity. The UE may perform one or more measurements using the CSI-RSs and may generate a CSI report according to a first type of codebook (such as a Type 1 single antenna panel codebook). The CSI report may include an indication of a set of one or more beams associated with a precoding matrix, where the indication of the set of one or more beams is based on a rank indicator being greater than at least two layers. The UE may then transmit the CSI report to the network entity.

### FIELD OF TECHNOLOGY

The following relates to wireless communications, including single antenna panel codebook.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support single antenna panel codebook. For example, the described techniques provide enhancements for codebook-based signaling at a user equipment (UE), which may increase the accuracy and precision of beam selection and channel state information (CSI) reporting. In some implementations, the UE may receive, from a network entity, a set of channel state information reference signals (CSI-RSs) associated with a plurality of CSI-RS antenna ports located at the network entity. The UE may perform one or more measurements for the CSI-RSs and may generate a CSI report according to a first type of codebook (such as a Type 1 single antenna panel codebook). In some aspects, the CSI report may include an indication of a set of one or more beams associated with a precoding matrix (such as a precoding matrix indicator (PMI)), where the indication of the set of one or more beams is based on a rank indicator being greater than at least two layers. The UE may then transmit the CSI report to the network entity.

A method for wireless communications by a UE is described. The method may include receiving, from a network entity, a set of CSI-RSs associated with a set of multiple CSI antenna ports, generating a CSI report according to a first type of codebook, where the CSI report includes an indication of a set of one or more beams associated with a precoding matrix, and where the indication of the set of one or more beams is based on a rank indicator being greater than at least two layers, and transmitting the CSI report to the network entity.

A UE for wireless communications is described. The UE may include one or more memories storing processor executable code, and one or more processors coupled with the one or more memories. The one or more processors may individually or collectively be operable to execute the code to cause the UE to receive, from a network entity, a set of CSI-RSs associated with a set of multiple CSI antenna ports, generate a CSI report according to a first type of codebook, where the CSI report includes an indication of a set of one or more beams associated with a precoding matrix, and where the indication of the set of one or more beams is based on a rank indicator being greater than at least two layers, and transmit the CSI report to the network entity.

Another UE for wireless communications is described. The UE may include means for receiving, from a network entity, a set of CSI-RSs associated with a set of multiple CSI antenna ports, means for generating a CSI report according to a first type of codebook, where the CSI report includes an indication of a set of one or more beams associated with a precoding matrix, and where the indication of the set of one or more beams is based on a rank indicator being greater than at least two layers, and means for transmitting the CSI report to the network entity.

A non-transitory computer-readable medium storing code for wireless communications is described. The code may include instructions executable by one or more processors to receive, from a network entity, a set of CSI-RSs associated with a set of multiple CSI antenna ports, generate a CSI report according to a first type of codebook, where the CSI report includes an indication of a set of one or more beams associated with a precoding matrix, and where the indication of the set of one or more beams is based on a rank indicator being greater than at least two layers, and transmit the CSI report to the network entity.

In some examples of the method, UEs, and non-transitory computer-readable medium described herein, the CSI report includes a set of multiple bits for each subband precoder of the first type of codebook and the rank indicator includes three layers or four layers.

In some examples of the method, UEs, and non-transitory computer-readable medium described herein, the indication of the set of one or more beams associated with the precoding matrix includes a first quantity of beams for wideband and a second quantity of beams for subband and the first quantity of beams for wideband may be adjusted by one half for the rank indicator of three layers or four layers based on the set of multiple bits for each subband precoder of the first type of codebook.

In some examples of the method, UEs, and non-transitory computer-readable medium described herein, the first quantity of beams for wideband may be based on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

In some examples of the method, UEs, and non-transitory computer-readable medium described herein, the indication of the set of one or more beams may be based on a scaling factor of one over a square root of a quantity of three times a value of the set of multiple CSI antenna ports.

In some examples of the method, UEs, and non-transitory computer-readable medium described herein, the indication of the set of one or more beams may be based on a scaling factor of one over a square root of a quantity of four times a value of the set of multiple CSI antenna ports.

In some examples of the method, UEs, and non-transitory computer-readable medium described herein, the set of multiple CSI antenna ports includes a quantity that may be greater than 32 CSI antenna ports and the method, apparatuses, and non-transitory computer-readable medium may include further operations, features, means, or instructions for selecting at least one beam of the set of one or more beams, where a direction of the at least one beam may be based on a pair of discrete Fourier transform (DFT) oversampling factors selected from a set of DFT oversampling factor pairs, and where at least one DFT oversampling pair includes both a first DFT oversampling factor associated with a vertical antenna polarization and a second DFT oversampling factor associated with a horizontal antenna polarization.

In some examples of the method, UEs, and non-transitory computer-readable medium described herein, the set of DFT oversampling factor pairs lacks a DFT oversampling pair including a zero value for both the first DFT oversampling factor associated with the vertical antenna polarization and the second DFT oversampling factor associated with the horizontal antenna polarization.

In some examples of the method, UEs, and non-transitory computer-readable medium described herein, the first DFT oversampling factor associated with the vertical antenna polarization and the second DFT oversampling factor associated with the horizontal antenna polarization may be indicative of the at least one beam in both a vertical dimension and a horizontal dimension.

In some examples of the method, UEs, and non-transitory computer-readable medium described herein, the set of multiple CSI antenna ports include greater than 16 CSI antenna ports and the method, apparatuses, and non-transitory computer-readable medium may include further operations, features, means, or instructions for selecting at least one beam of the set of one or more beams in accordance with a unified codebook associated with the at least two layers of the precoding matrix, where the at least two layers of the precoding matrix include two layers, three layers, four layers, or any combination thereof.

In some examples of the method, UEs, and non-transitory computer-readable medium described herein, the set of one or more beams may be based on a set of respective vertically polarized antenna ports multiplied by respective DFT oversampling factors in a vertical dimension and a set of respective horizontally polarized antenna ports multiplied by respective DFT oversampling factors in a horizontal dimension.

In some examples of the method, UEs, and non-transitory computer-readable medium described herein, the set of multiple CSI antenna ports include at least 32 CSI antenna ports and the rank indicator includes three layers or four layers and a quantity of available beam values for a vertical dimension may be adjusted by one half for quantities of vertically polarized antenna ports greater than one.

In some examples of the method, UEs, and non-transitory computer-readable medium described herein, a quantity of available beam values for the vertical dimension may be adjusted by one half relative to a quantity of available beam values for a horizontal dimension.

In some examples of the method, UEs, and non-transitory computer-readable medium described herein, the set of multiple CSI antenna ports includes a quantity that may be greater than 32 CSI antenna ports.

A method for wireless communications by a network entity is described. The method may include outputting a set of CSI-RSs via a set of multiple CSI antenna ports at the network entity and receiving a CSI report according to a first type of codebook, where the CSI report includes an indication of a set of one or more beams associated with a precoding matrix, and where the indication of the set of one or more beams is based on a rank indicator being greater than at least two layers.

A network entity for wireless communications is described. The network entity may include one or more memories storing processor executable code, and one or more processors coupled with the one or more memories. The one or more processors may individually or collectively be operable to execute the code to cause the network entity to output a set of CSI-RSs via a set of multiple CSI antenna ports at the network entity and receive a CSI report according to a first type of codebook, where the CSI report includes an indication of a set of one or more beams associated with a precoding matrix, and where the indication of the set of one or more beams is based on a rank indicator being greater than at least two layers.

Another network entity for wireless communications is described. The network entity may include means for outputting a set of CSI-RSs via a set of multiple CSI antenna ports at the network entity and means for receiving a CSI report according to a first type of codebook, where the CSI report includes an indication of a set of one or more beams associated with a precoding matrix, and where the indication of the set of one or more beams is based on a rank indicator being greater than at least two layers.

A non-transitory computer-readable medium storing code for wireless communications is described. The code may include instructions executable by one or more processors to output a set of CSI-RSs via a set of multiple CSI antenna ports at the network entity and receive a CSI report according to a first type of codebook, where the CSI report includes an indication of a set of one or more beams associated with a precoding matrix, and where the indication of the set of one or more beams is based on a rank indicator being greater than at least two layers.

In some examples of the method, network entities, and non-transitory computer-readable medium described herein, the CSI report includes a set of multiple bits for each subband precoder of the first type of codebook and the rank indicator includes three layers or four layers.

In some examples of the method, network entities, and non-transitory computer-readable medium described herein, the indication of the set of one or more beams associated with the precoding matrix includes a first quantity of beams for wideband and a second quantity of beams for subband and the first quantity of beams for wideband may be adjusted by one half for the rank indicator of three layers or four layers based on the set of multiple bits for each subband precoder of the first type of codebook.

In some examples of the method, network entities, and non-transitory computer-readable medium described herein, the first quantity of beams for wideband may be based on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

In some examples of the method, network entities, and non-transitory computer-readable medium described herein, the indication of the set of one or more beams may be based on a scaling factor of one over a square root of a quantity of three times a value of the set of multiple CSI antenna ports.

In some examples of the method, network entities, and non-transitory computer-readable medium described herein, the indication of the set of one or more beams may be based on a scaling factor of one over a square root of a quantity of four times a value of the set of multiple CSI antenna ports.

In some examples of the method, network entities, and non-transitory computer-readable medium described herein, the set of multiple CSI antenna ports includes a quantity that may be greater than 32 CSI antenna ports and the method, apparatuses, and non-transitory computer-readable medium may include further operations, features, means, or instructions for receiving an indication of a selection of at least one beam of the set of one or more beams, where a direction of the at least one beam may be based on a pair of DFT oversampling factors selected from a set of DFT oversampling factor pairs, and where at least one DFT oversampling pair includes both a first DFT oversampling factor associated with a vertical antenna polarization and a second DFT oversampling factor associated with a horizontal antenna polarization.

In some examples of the method, network entities, and non-transitory computer-readable medium described herein, the set of DFT oversampling factor pairs lacks a DFT oversampling pair including a zero value for both the first DFT oversampling factor associated with the vertical antenna polarization and the second DFT oversampling factor associated with the horizontal antenna polarization.

In some examples of the method, network entities, and non-transitory computer-readable medium described herein, the first DFT oversampling factor associated with the vertical antenna polarization and the second DFT oversampling factor associated with the horizontal antenna polarization may be indicative of the at least one beam in both a vertical dimension and a horizontal dimension.

In some examples of the method, network entities, and non-transitory computer-readable medium described herein, the set of multiple CSI antenna ports include greater than 16 CSI antenna ports and the method, apparatuses, and non-transitory computer-readable medium may include further operations, features, means, or instructions for obtaining an indication of a selection of at least one beam of the set of one or more beams in accordance with a unified codebook associated with the at least two layers of the precoding matrix, where the at least two layers of the precoding matrix include two layers, three layers, four layers, or any combination thereof.

In some examples of the method, network entities, and non-transitory computer-readable medium described herein, the set of one or more beams may be based on a set of respective vertically polarized antenna ports multiplied by respective DFT oversampling factors in a vertical dimension and a set of respective horizontally polarized antenna ports multiplied by respective DFT oversampling factors in a horizontal dimension.

In some examples of the method, network entities, and non-transitory computer-readable medium described herein, the set of multiple CSI antenna ports include at least 32 CSI antenna ports and the rank indicator includes three layers or four layers and a quantity of available beam values for a vertical dimension may be adjusted by one half for quantities of vertically polarized antenna ports greater than one.

In some examples of the method, network entities, and non-transitory computer-readable medium described herein, a quantity of available beam values for the vertical dimension may be adjusted by one half relative to a quantity of available beam values for a horizontal dimension.

In some examples of the method, network entities, and non-transitory computer-readable medium described herein, the set of multiple CSI antenna ports includes a quantity that may be greater than 32 CSI antenna ports.

### BRIEF DESCRIPTION OF THE DRAWINGS

FIGS. 1, 2, and 3 show examples of wireless communications systems that support single antenna panel codebook in accordance with one or more aspects of the present disclosure.

FIG. 4 shows an example of a beam width management configuration that supports single antenna panel codebook in accordance with one or more aspects of the present disclosure.

FIG. 5 shows an example of a process flow that supports single antenna panel codebook in accordance with one or more aspects of the present disclosure.

FIGS. 6 and 7 show block diagrams of devices that support single antenna panel codebook in accordance with one or more aspects of the present disclosure.

FIG. 8 shows a block diagram of a communications manager that supports single antenna panel codebook in accordance with one or more aspects of the present disclosure.

FIG. 9 shows a diagram of a system including a device that supports single antenna panel codebook in accordance with one or more aspects of the present disclosure.

FIGS. 10 and 11 show block diagrams of devices that support single antenna panel codebook in accordance with one or more aspects of the present disclosure.

FIG. 12 shows a block diagram of a communications manager that supports single antenna panel codebook in accordance with one or more aspects of the present disclosure.

FIG. 13 shows a diagram of a system including a device that supports single antenna panel codebook in accordance with one or more aspects of the present disclosure.

FIGS. 14 and 15 show flowcharts illustrating methods that support single antenna panel codebook in accordance with one or more aspects of the present disclosure.

### DETAILED DESCRIPTION

To achieve accurate beamforming, a wireless communications system may support channel state information (CSI) measurement and reporting. For example, a network entity may transmit one or more CSI reference signals (CSI-RSs) to one or more user equipment (UEs), which may use the one or more CSI-RSs to perform various channel measurement and beam selection. In some aspects, a UE may transmit a CSI report based on the CSI-RSs, which may include one or more measurements (e.g., beam related measurements) that may allow the network entity to calculate a precoding matrix for beamforming and user scheduling. In some aspects, the CSI reporting process may be implemented using one or more codebooks. For example, a UE may transmit a precoding matrix indicator (PMI) which indicates channel characteristics with a chosen codebook scheme (e.g., a codebook scheme or a set of one or more beams chosen or selected by the UE). Different codebooks for generating the CSI report may include a Type 1 codebook, a Type 2 codebook, and an enhanced Type (eType) 2 codebook. Type 1 and Type 2 codebooks are different in that Type 1 codebooks select a beam from a group of beams, whereas Type 2 codebooks select a group of beams and linearly combine the beams within the group.

In some aspects, the Type 1 codebook may support codebook-based downlink transmissions, and in some cases may support a maximum of 32 CSI-RS ports for up to 8 communication layers (e.g., spatial layers associated with multiple-input multiple-output (MIMO) operation, layers for CSI reporting, a number of columns in a precoding matrix or rank of the precoding matrix). Some enhancements, however, may allow the Type 1 codebook to support more than 32 CSI-RS antenna ports (e.g., up to 128 CSI-RS ports). Such an increase in the number of CSI-RS ports may also allow for an extension of the Type 1 codebook to accommodate up to 128 ports, which may allow for further optimizations for performance and efficiency of the Type 1 codebook. For example, the use of more CSI ports at the network entity may allow for more accurate channel estimation and more precise beam selection. In addition, while some Type 1 codebooks support transmissions for up to 2 layers, some enhancements may allow for Type 1 codebooks to support greater than 2 layers, such as 3 and 4 layers.

A wireless communications system may support various different extensions to a Type 1 single antenna panel codebook for greater than 2 layers, and with greater than 32 CSI-RS antenna ports. In some implementations, the Type 1 codebook may be extended to 3 and 4 layers, which the UE may support by reporting 3 bits per subband (e.g., for reporting the PMI). In some examples, the UE may support additional or alternative configurable beam options, where the UE may choose beam directions in both vertical and horizontal dimensions (in order to reduce inter-layer interference from higher layers). In some other implementations, the UE may utilize a unified codebook design for less than 16 and greater than or equal to 16 CSI-RS antenna ports for up to 4 layers (e.g., the unified codebook will be unified or the same for 2 layers, 3 layers, and 4 layers). Additional techniques may also be implemented by the UE in 3 and 4 layer reporting to widen beams in the vertical dimension by reducing the number of beams options in the vertical dimension by half.

Aspects of the disclosure may be implemented to realize one or more potential advantages. For example, support for increased quantities of CSI-RS antenna ports may allow for increased coverage and more accurate channel estimation and beam selection. Additionally or alternatively, the extension of CSI reporting to 3 and 4 layers with enhanced codebook designs may further optimize the performance and efficiency of the UE beam selection, beam reporting, and performance. Additionally or alternatively, the techniques described herein may allow for beam steering in multiple dimensions, which may allow for increased beam selection options and may further beam selection accuracy and performance for the UE. Additionally or alternatively, some of the techniques described herein may allow for the dynamic adjustment of beam width to support effective signal propagation.

Aspects of the disclosure are initially described in the context of wireless communications systems. Aspects of the disclosure are further illustrated by and described with reference to a beam width management configuration, a process flow, apparatus diagrams, system diagrams, and flowcharts that relate to single antenna panel codebook.

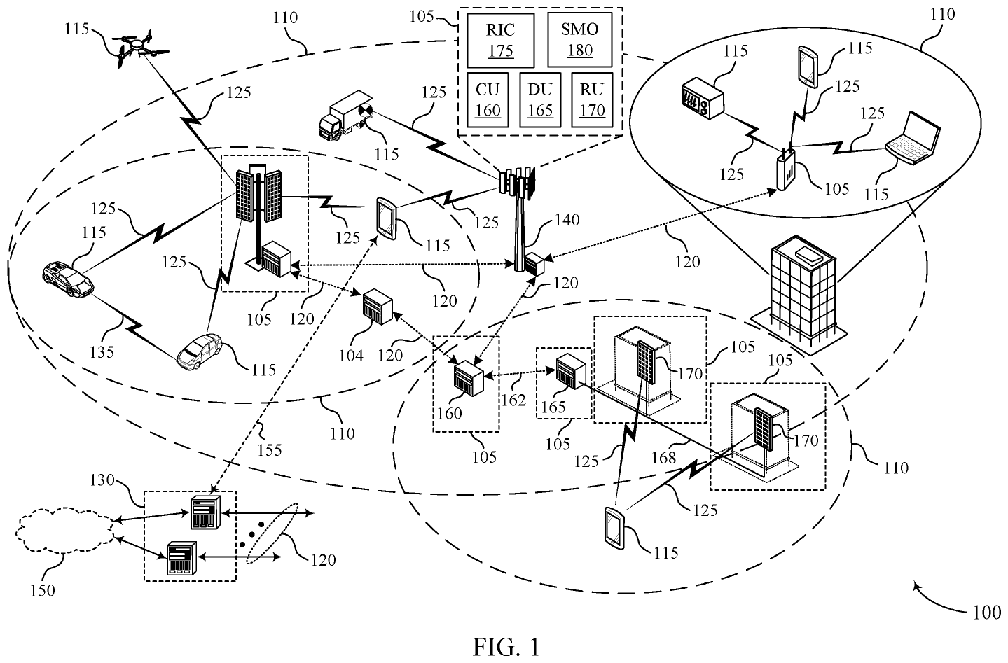

FIG. 1 shows an example of a wireless communications system 100 that supports single antenna panel codebook in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system may support MIMO (and extensions such as massive MIMO) to improve system performance. For example, MIMO techniques may increase transmission diversity, spatial multiplexing gain, transmission directivity, spectral efficiency, and reliability for communications between devices. At least some of the factors for increased performance and high transmission directivity associated with massive MIMO may rely on beamforming, which may enable multi-user spatial multiplexing. To achieve accurate beamforming, the wireless communications system 100 may support CSI measurement and reporting. For example, a network entity 105 may transmit one or more CSI-RSs to one or more UEs 115, and may receive feedback information in the form of one or more CSI reports from the one or more UEs 115. In some aspects, a CSI report may include one or more measurements (e.g., beam related measurements) performed by a UE 115, which may allow the network entity 105 to calculate a precoding matrix for beamforming and user scheduling. In some aspects, the CSI reporting process may be achieved using one or more codebooks and the feedback of codewords by the UE. In some implementations, a codebook may refer to a set of pre-defined precoders (e.g., codewords), and the one or more UEs 115 may transmit and indication of the indices of the codewords to the network entity 105. In some other implementations, a codebook may include a CSI reporting mechanism including the measurements that allow the network entity 105 to compute the precoding matrix.

A CSI reporting framework may support different codebook designs, which may allow the network entity 105 to obtain a precoding matrix from CSI reporting provided by the UE 115. For example, a UE 115 may transmit a precoding matrix indicator (PMI) which indicates channel characteristics with a chosen codebook scheme (e.g., a codebook scheme or a set of one or more beams chosen or selected by the UE 115). Different codebooks for generating the CSI report at the UE 115 are currently defined, including a Type 1 codebook, a Type 2 codebook, and an enhanced Type (eType) 2 codebook. Type 1 and Type 2 codebooks are different in that Type 1 codebooks select a beam from a group of beams, whereas Type 2 codebooks select a group of beams and linearly combine the beams within the group. Type 2 codebooks are often used for MIMO applications, while Type 1 codebooks are often used for single user MIMO cases. Type 2 codebooks may support up to rank 2 (i.e., 2 layers), and enhanced Type 2 codebooks extend the Type 2 codebook to rank 4 (i.e., 4 layers). In some aspects, the different layers for codebook and CSI reporting may refer to spatial layers associated with MIMO operation, layers for CSI reporting, a number of columns in a precoding matrix or rank of the precoding matrix. For example, layers may correspond to streams in MIMO-enabled spatial multiplexing (e.g., for transmitting signals simultaneously in the same time and/or frequency resources).

In some aspects, the Type 1 codebook may support codebook-based downlink transmissions, and in some cases may support a maximum of 32 CSI-RS ports for up to 8 layers. Some enhancements, however, the Type 1 codebook may support more than 32 CSI-RS ports (e.g., up to 128 CSI-RS ports). Such an increase in the number of CSI-RS ports may also allow for an extension of the Type 1 codebook to accommodate up to 128 ports, which may allow for further optimizations for performance and efficiency of the Type 1 codebook.

In Type 1 CSI (e.g., CSI measurement and reporting according to a Type 1 single antenna panel codebook), a UE 115 may select a PMI from a predefined DFT-codebook. For example, a network entity 105 may sends one or more CSI-RSs or downlink channels to the UE 115, and the UE may select and signal the PMI to the network entity after performing channel estimation. In some examples, the reported PMI reflects may include beam information including a beam selection and co-phasing information among the dual-polarized antennas. In some implementations, the number of available beams in this a Type 1 codebook may be determined by the number of CSI-RS ports at the network entity 105 (e.g., which may be greater than 32 CSI-RS ports) and the degree of DFT-oversampling. Specifically, the factors for determining the total number of beams in the codebook are represented by N₁, NT₂, O₁, O₂, where N₁ denotes the number of antenna ports in a horizontal dimension (e.g., horizontally polarized antenna ports), NT₂ denotes the number of antenna ports in a vertical dimension (e.g., vertically polarized antenna ports), O₁ represents a DFT beam oversampling factor for the horizontal dimension, and O₂ represents the DFT beam oversampling factor in the vertical dimension. Some example configurations of (N₁, N₂) and (O₁, O₂) relative to some corresponding quantities of CSI-RS antenna ports may be given in Table 1:

TABLE 1

| Number of | | |
|---|---|---|
| CSI-RS antenna | | |
| ports, P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

In some aspects, the PMI structure for a Type 1 codebook may be configured or expressed in the form of a matrix W, where W=W₁W₂ with W₁ being indicative of the wideband information of the channel and W₂ detailing its sub-band information of the channel. In some examples, W₁ may depend (at least in part) on i_{1,1} and i_{1,2}, which may be indices that are associated with horizontal and vertical beam indices (e.g., possible beam options for selection by the UE 115), and the overhead for reporting wideband PMI may be equal to ┌log₂(N₁O₁)┐+┌log₂(N₂O₂)┐ bits. In some examples, W₂ may depend (at least in part) on i₂, which nay be indicative of co-phasing information for the precoding matrix. The overhead for reporting W₂ (e.g., the co-phasing matrix) can be up to two bits per sub-band.

The Type 1 codebook may support different modes of operation, including at least Mode 1 and Mode 2 modes of operation. For Mode 1 of the Type 1 codebook, the UE 115 may evaluate a CSI resource (e.g., a CSI-RS) and may identify a single DFT-beam from a pre-established codebook, which may be designated as a wideband PMI. In some aspects, the UE 115 may determine or calculate a co-phasing value to effectively align the cross-polarization for CSI-RS antenna ports. In some aspects, the overhead for reporting the wideband PMI for the Type 1 codebook (denoted as W₁) may be calculated as ┌log₂(N₁O₁)┐±┌log₂(N₂O₂)┐ bits, and the wideband PMI may be used to steer the beam index of the selected beam in both horizontal and vertical dimensions. In some examples, the overhead reporting for the co-phasing may up to two (or more) bits per subband. In some examples for two layer reporting for Mode 1 of the Type 1 codebook, the codebook for using antenna ports 3000 to 2999 P_{CSI-RS} may be expressed in Table 2:

TABLE 2
codebookMode = 1

| i_{1,1} | i_{1,2} | i₂ | |
|---|---|---|---|
| 0, 1, . . . , N₁O₁ − 1 | 0, . . . , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 2 )}$ |

$where {W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ]$
and the mapping from i_{1,3} to k₁ and k₂ is given separately (Table 8).

For Mode 2 of the Type 1 codebook, the codebook may be organized into a set of beam groups (e.g., one or more beam groups), where each beam group includes up to four beams. In some cases, the UE 115 may evaluate or perform one or more measurements for a CSI resource (e.g., a CSI-RS) and identifies or selects a beam group, which the UE 115 may then report to the network entity 105 as a wideband PMI or W₁. Then, within each subband, the IE 115 may select one beam of the up to four available beams in W₁ and may communicate an indication of the selected beam to the network entity 105. In such cases, the overhead of PMI reporting in Mode 2 for the Type 1 codebook may be determined or calculated as

$$⌈ {log}_{2} ( \frac{{N}_{1} {O}_{1}}{2} ) ⌉ + ⌈ {log}_{2} ( \frac{{N}_{2} {O}_{2}}{2} ) ⌉ bits .$$

In some examples, the PMI overhead calculation may be used to identify the index of the first beam in the beam group per dimension (e.g., a beam index for the horizontal dimension of the beam and a beam index for a vertical dimension of the beam), and an additional up to 4 bits per sub-band may be used to select one of the up to four available beams with a co-phasing factor. For example, the UE 115 may have multiple different choices for selecting a beam per subband. In some examples for two layer reporting for Mode 2 of the Type 1 codebook, the codebook for using antenna ports 3000 to 2999+P_{CSI-RS} may be expressed in Table 3:

TABLE 3
codebookMode = 2, N₂ > 1

| | | i₂ | |
|---|---|---|---|
| i_{1,1} | i_{1,2} | 0 | 1 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 2 {i}_{1 , 2} , 2 {i}_{1 , 2} + {k}_{2} , 0}^{( 2 )}$ | ${W}_{2 {i}_{1 , 1} , 2 {i}_{1 , 1} + {k}_{1} , 2 {i}_{1 , 2} , 2 {i}_{1 , 2} + {k}_{2} , 1}^{( 2 )}$ |
| | | i₂ | |
| i_{1,1} | i_{1,2} | 2 | 3 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 2 {i}_{1 , 2} , 2 {i}_{1 , 2} + {k}_{2} , 0}^{( 2 )}$ | ${W}_{2 {i}_{1 , 1} + 1 , 2 {i}_{1 , 1} + 1 + {k}_{1} , 2 {i}_{1 , 2} , 2 {i}_{1 , 2} + {k}_{2} , 1}^{( 2 )}$ |
| | | i₂ | |
| i_{1,1} | i_{1,2} | 4 | 5 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 2 {i}_{1 , 2} , + 1 , 2 {i}_{1 , 2} + 1 + {k}_{2} , 0}^{( 2 )}$ | ${W}_{2 {i}_{1 , 1} , 2 {i}_{1 , 1} + {k}_{1} , 2 {i}_{1 , 2} , + 1 , 2 {i}_{1 , 2} + 1 + {k}_{2} , 1}^{( 2 )}$ |
| | | i₂ | |
| i_{1,1} | i_{1,2} | 6 | 7 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 2 {i}_{1 , 2} , + 1 , 2 {i}_{1 , 2} + 1 + {k}_{2} , 0}^{( 2 )}$ | ${W}_{2 {i}_{1 , 1} + 1 , 2 {i}_{1 , 1} + 1 + {k}_{1} , 2 {i}_{1 , 2} + 1 , 2 {i}_{1 , 2} + 1 + {k}_{2} , 1}^{( 2 )}$ |

$where {W}_{l , {l}^{′} , m , {m}^{′} , n}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ]$
and the mapping from i_{1,3} to k₁ and k₂ is given separately (Table 8).

In some aspects, the use of more CSI ports at the network entity may allow for more accurate channel estimation and more precise beam selection. In addition, while some Type 1 codebooks support transmissions for up to 2 layers (e.g., MIMO layers, spatial layers), some enhancements may allow for Type 1 codebooks to support greater than 2 layers, such as 3 and 4 layers. In some aspects, the wireless communications system 100 may support various different extensions to a Type 1 single antenna panel codebook for greater than 2 layers, and with greater than 32 CSI-RS antenna ports. In some implementations, the Type 1 codebook may be extended to 3 and 4 layers, which the UE 115 may support by reporting 3 bits per subband (e.g., for reporting the PMI). In some examples, the UE 115 may support additional or alternative configurable beam options, where the UE may choose beam directions in both vertical and horizontal dimensions. In some other implementations, the UE 115 may utilize a unified codebook design for less than 16 and greater than 16 CSI-RS antenna ports for up to 4 layers (e.g., the unified codebook will be unified or the same for 2 layers, 3 layers, and 4 layers). Additional techniques may also be implemented by the UE 115 in 3 and 4 layer reporting to widen beams in the vertical dimension by reducing the number of beams options in the vertical dimension by half.

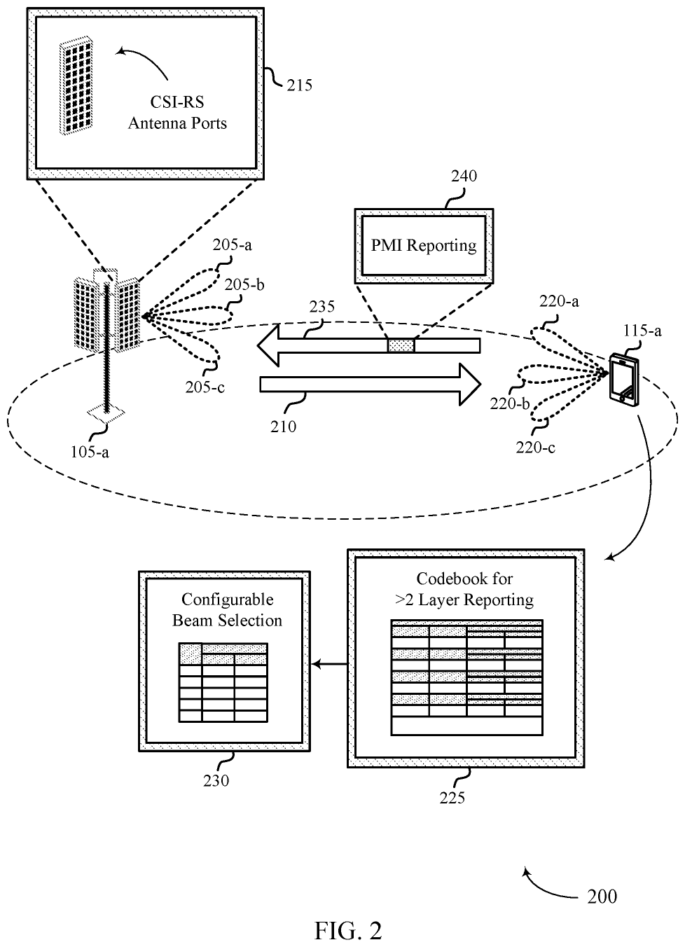

FIG. 2 shows an example of a wireless communications system 200 that supports single antenna panel codebook in accordance with one or more aspects of the present disclosure. For example, the wireless communications system 200 may support communications between a network entity 105-a and a UE 115-a, each of which may be examples of corresponding devices described with reference to FIG. 1. In some aspects, the UE 115-a and the network entity 105-a may support CSI measurement and reporting associated with a Mode 2 Type 1 single antenna panel codebook for an increased quantity of CSI-RS antenna ports at the network entity 105-a, and PMI reporting for an increased number of layers (e.g., for layers 3 and 4).

The network entity 105-a may output one or more beams (e.g., beam 205-a, beam 205-b, beam 205-c) for communications 210 with the UE 115-a. In some examples, the network entity may output, via the one or more beams, a set of CSI-RSs via a set of CSI-RS antenna ports 215. The CSI-RSs may allow the UE 115-a to perform one or more measurements (e.g., channel estimation, reference signal receive power (RSRP), reference signal receive quality (RSRQ), beam directionality measurements, among other measurements) to determine one or more suitable beams with which to communicate with the network entity 105-a. The UE 115-a may receive the set of CSI-RSs via a set of receive beams (e.g., beam 220-a, beam 220-b, beam 220-c) and may perform a set of measurements on the CSI-RSs in order to select one or more beams and generate a CSI report to send to the network entity 105-a.

In some examples, the UE 115-a may utilize a Type 1 single antenna panel codebook 225 for Mode 2 in order to select different beams from one or more beam groups per subband (e.g., for 1 to 2 layers). In some implementations however, as the set of CSI-RS antenna ports 215 increases in quantity at the network entity 105-a, the average rank of the precoding matrix may correspondingly increase, such that the UE 115-a may utilize a Type 1 single antenna panel codebook for Mode 2 in order to select different beams from one or more beam groups per subband for greater than 2 layers (e.g., for 3 or four layers). The UE 115-a may utilize different codebooks based on different layers (e.g., layer 3 and layer 4) and may transmit, via signaling 235, a PMI 240 which is included as part of (or with) the CSI report.

The design of the Mode 2 Type 1 single antenna panel codebook may enable the UE 115 to select from a larger set of beam options (e.g., for different beams per subband). In order to support the larger selection of beam options, the UE 115-a may incur increased signaling overhead for PMI reporting relative to PMI reporting for the Mode 1 Type 1 single antenna panel codebook. For example, for layers 1 and 2 layers, the cost of reporting PMI for the Mode 2 Type 1 single antenna panel codebook may be increased by 2 bits for 1 and 2 layers relative to the Mode 1 Type 1 single antenna panel codebook. In addition, by extending the Mode 2 Type 1 single antenna panel codebook design to layers 3 and 4, the UE 115-a may report 3 bits to indicate a subband precoder (e.g., corresponding to 8 beam options for i_{1,2}) per subband, as compared to 1 bit required in the Mode 1 Type 1 single antenna panel codebook design. In some aspects, the cost of bits for reporting in Mode 2 is adjusted for layers 1 and 2 by reducing the i_{1,1} and i_{1,2} (e.g., the number of beam options available for selection by the UE 115-a) options by half for wideband. Additionally or alternatively, the i_{1,1} and i_{1,2} values may be reduced to half for layers 3 and 4 to compensate for the additional bits added for per-subband reporting for the Mode 2 Type 1 single antenna panel codebook design.

In some examples for 3 layer reporting for Mode 2 of the Type 1 codebook, the codebook for using antenna ports 3000 to 2999+P_{CSI-RS} may be expressed in Table 4:

TABLE 4
codebookMode = 2, N₂ > 1

| | | i₂ | |
|---|---|---|---|
| i_{1,1} | i_{1,2} | 0 | 1 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 2 {i}_{1 , 2} , 2 {i}_{1 , 2} + {k}_{2} , 0}^{( 3 )}$ | ${W}_{2 {i}_{1 , 1} , 2 {i}_{1 , 1} + {k}_{1} , 2 {i}_{1 , 2} , 2 {i}_{1 , 2} + {k}_{2} , 1}^{( 3 )}$ |
| | | i₂ | |
| i_{1,1} | i_{1,2} | 2 | 3 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 2 {i}_{1 , 2} , 2 {i}_{1 , 2} + {k}_{2} , 0}^{( 3 )}$ | ${W}_{2 {i}_{1 , 1} + 1 , 2 {i}_{1 , 1} + 1 + {k}_{1} , 2 {i}_{1 , 2} , 2 {i}_{1 , 2} + {k}_{2} , 1}^{( 3 )}$ |
| | | i₂ | |
| i_{1,1} | i_{1,2} | 4 | 5 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 2 {i}_{1 , 2} + 1 , 2 {i}_{1 , 2} + 1 + {k}_{2} , 0}^{( 3 )}$ | ${W}_{2 {i}_{1 , 1} , 2 {i}_{1 , 1} + {k}_{1} , 2 {i}_{1 , 2} + 1 , 2 {i}_{1 , 2} + 1 + {k}_{2} , 1}^{( 3 )}$ |
| | | i₂ | |
| i_{1,1} | i_{1,2} | 6 | 7 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 2 {i}_{1 , 2} + 1 , 2 {i}_{1 , 2} + 1 + {k}_{2} , 0}^{( 3 )}$ | ${W}_{2 {i}_{1 , 1} + 1 , 2 {i}_{1 , 1} + 1 + {k}_{1} , 2 {i}_{1 , 2} + 1 , 2 {i}_{1 , 2} + 1 + {k}_{2} , 1}^{( 3 )}$ |

$where {W}_{l , {l}^{′} , m , {m}^{′} , n}^{( 3 )} = \frac{1}{\sqrt{3 {P}_{CSIRS}}} [ \begin{matrix}{v}_{l , m} & {v}_{{l}^{′} , {m}^{′}} & {v}_{l , m} \\ {ϕ}_{n} {v}_{l , m} & {ϕ}_{n} {v}_{{l}^{′} , {m}^{′}} & - {ϕ}_{n} {v}_{l , m}\end{matrix} ]$
and the mapping from i_{1,3} to k₁ and k₂ is given in Table 8, herein.

### and in Table 5:

TABLE 5
codebookMode = 2, N₂ = 1

| | | i₂ | |
|---|---|---|---|
| i_{1,1} | i_{1,2} | 0 | 1 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 0 , 0 , 0}^{( 3 )}$ | ${W}_{2 {i}_{1 , 1} , 2 {i}_{1 , 1} + {k}_{1} , 0 , 0 , 1}^{( 3 )}$ |
| | | i₂ | |
| i_{1,1} | i_{1,2} | 2 | 3 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 0 , 0 , 0}^{( 3 )}$ | ${W}_{2 {i}_{1 , 1} + 1 , 2 {i}_{1 , 1} + 1 + {k}_{1} , 0 , 0 , 1}^{( 3 )}$ |
| | | i₂ | |
| i_{1,1} | i_{1,2} | 4 | 5 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 2 , 2 {i}_{1 , 1} + 2 + {k}_{1} , 0 , 0 , 0}^{( 3 )}$ | ${W}_{2 {i}_{1 , 1} + 2 , 2 {i}_{1 , 1} + 2 + {k}_{1} , 0 , 0 , 1}^{( 3 )}$ |
| | | i₂ | |
| i_{1,1} | i_{1,2} | 6 | 7 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 3 , 2 {i}_{1 , 1} + 3 + {k}_{1} , 0 , 0 , 0}^{( 3 )}$ | ${W}_{2 {i}_{1 , 1} + 3 , 2 {i}_{1 , 1} + 3 + {k}_{1} , 0 , 0 , 1}^{( 3 )}$ |

$where {W}_{l , {l}^{′} , m , {m}^{′} , n}^{( 3 )} = \frac{1}{\sqrt{3 {P}_{CSIRS}}} [ \begin{matrix}{v}_{l , m} & {v}_{{l}^{′} , {m}^{′}} & {v}_{l , m} \\ {ϕ}_{n} {v}_{l , m} & {ϕ}_{n} {v}_{{l}^{′} , {m}^{′}} & - {ϕ}_{n} {v}_{l , m}\end{matrix} ]$
and the mapping from i_{1,3} to k₁ and k₂ is given in Table 8, herein.

In some examples for 4 layer reporting for Mode 2 of the Type 1 codebook, the codebook for using antenna ports 3000 to 2999+P_{CSI-RS} may be expressed in Table 6:

TABLE 6
codebookMode = 2, N₂ > 1

| | | i₂ | |
|---|---|---|---|
| i_{1,1} | i_{1,2} | 0 | 1 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 2 {i}_{1 , 2} , 2 {i}_{1 , 2} + {k}_{2} , 0}^{( 4 )}$ | ${W}_{2 {i}_{1 , 1} , 2 {i}_{1 , 1} + {k}_{1} , 2 {i}_{1 , 2} , 2 {i}_{1 , 2} + {k}_{2} , 1}^{( 4 )}$ |
| | | i₂ | |
| i_{1,1} | i_{1,2} | 2 | 3 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 2 {i}_{1 , 2} , 2 {i}_{1 , 2} + {k}_{2} , 0}^{( 4 )}$ | ${W}_{2 {i}_{1 , 1} + 1 , 2 {i}_{1 , 1} + 1 + {k}_{1} , 2 {i}_{1 , 2} , 2 {i}_{1 , 2} + {k}_{2} , 1}^{( 4 )}$ |
| | | i₂ | |
| i_{1,1} | i_{1,2} | 4 | 5 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 2 {i}_{1 , 2} + 1 , 2 {i}_{1 , 2} + 1 + {k}_{2} , 0}^{( 4 )}$ | ${W}_{2 {i}_{1 , 1} , 2 {i}_{1 , 1} + {k}_{1} , 2 {i}_{1 , 2} + 1 , 2 {i}_{1 , 2} + 1 + {k}_{2} , 1}^{( 4 )}$ |
| | | i₂ | |
| i_{1,1} | i_{1,2} | 6 | 7 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 2 {i}_{1 , 2} + 1 , 2 {i}_{1 , 2} + 1 + {k}_{2} , 0}^{( 4 )}$ | ${W}_{2 {i}_{1 , 1} + 1 , 2 {i}_{1 , 1} + 1 + {k}_{1} , 2 {i}_{1 , 2} + 1 , 2 {i}_{1 , 2} + 1 + {k}_{2} , 1}^{( 4 )}$ |

$where {W}_{l , {l}^{′} , m , {m}^{′} , n}^{( 4 )} = \frac{1}{\sqrt{4 {P}_{CSIRS}}} [ \begin{matrix}{v}_{l , m} & {v}_{{l}^{′} , {m}^{′}} & {v}_{l , m} & {v}_{{l}^{′} , {m}^{′}} \\ {ϕ}_{n} {v}_{l , m} & {ϕ}_{n} {v}_{{l}^{′} , {m}^{′}} & - {ϕ}_{n} {v}_{l , m} & - {ϕ}_{n} {v}_{{l}^{′} , {m}^{′}}\end{matrix} ]$
and the mapping from i_{1,3} to k₁ and k₂ is given in Table 8, herein.

### and in Table 7:

TABLE 7
codebookMode = 2, N₂ = 1

| | | i₂ | |
|---|---|---|---|
| i_{1,1} | i_{1,2} | 0 | 1 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} , 2 {i}_{1 , 1} + {k}_{1} , 0 , 0 , 0}^{( 4 )}$ | ${W}_{2 {i}_{1 , 1} , 2 {i}_{1 , 1} + {k}_{1} , 0 , 0 , 1}^{( 4 )}$ |
| | | i₂ | |
| i_{1,1} | i_{1,2} | 2 | 3 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 1 , 2 {i}_{1 , 1} + 1 + {k}_{1} , 0 , 0 , 0}^{( 4 )}$ | ${W}_{2 {i}_{1 , 1} + 1 , 2 {i}_{1 , 1} + 1 + {k}_{1} , 0 , 0 , 1}^{( 4 )}$ |
| | | i₂ | |
| i_{1,1} | i_{1,2} | 4 | 5 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 2 , 2 {i}_{1 , 1} + 2 + {k}_{1} , 0 , 0 , 0}^{( 4 )}$ | ${W}_{2 {i}_{1 , 1} + 2 , 2 {i}_{1 , 1} + 2 + {k}_{1} , 0 , 0 , 1}^{( 4 )}$ |
| | | i₂ | |
| i_{1,1} | i_{1,2} | 6 | 7 |
| $0 , … , \frac{{N}_{1} {O}_{1}}{2} - 1$ | $0 , … , \frac{{N}_{2} {O}_{2}}{2} - 1$ | ${W}_{2 {i}_{1 , 1} + 3 , 2 {i}_{1 , 1} + 3 + {k}_{1} , 0 , 0 , 0}^{( 4 )}$ | ${W}_{2 {i}_{1 , 1} + 3 , 2 {i}_{1 , 1} + 3 + {k}_{1} , 0 , 0 , 1}^{( 4 )}$ |

$where {W}_{l , {l}^{′} , m , {m}^{′} , n}^{( 4 )} = \frac{1}{\sqrt{4 {P}_{CSIRS}}} [ \begin{matrix}{v}_{l , m} & {v}_{{l}^{′} , {m}^{′}} & {v}_{l , m} & {v}_{{l}^{′} , {m}^{′}} \\ {ϕ}_{n} {v}_{l , m} & {ϕ}_{n} {v}_{{l}^{′} , {m}^{′}} & - {ϕ}_{n} {v}_{l , m} & - {ϕ}_{n} {v}_{{l}^{′} , {m}^{′}}\end{matrix} ]$
and the mapping from i_{1,3} to k₁ and k₂ is given in Table 8, herein.

In some implementations, the UE 115-a may select different beams for 1, 2, 3, or 4 layers when the set of CSI-RS antenna ports 215 has a quantity less than 16 ports. For example, the UE 115-a may select a beam for first layer, and then selects beams for other layers using fixed offsets when the set of CSI-RS antenna ports 215 has a quantity that is greater than or equal to 16 ports (e.g., for 3 to 8 layers). In some examples, however, the network entity 105-a may employ a greater number of CSI-RS antenna ports (e.g., greater than 32 CSI-RS antenna ports) that may have a higher average rank. In such examples, the UE 115-a may use fixed offsets that are at least similar to the fixed offsets used for 2 layers, 3 layers, and 4 layers (e.g., when the number of CSI-RS antenna ports are less than 16 ports). In some aspects, the offsets and beam selection may be configurable for at least layer 3 and layer 4 for when the quantity of CSI-RS antenna ports exceeds 32 ports.

In some cases, the UE 115-a may implement Table 8 (e.g., table 230) for selecting beams for layers 3 and 4, which maps i_{1,3} to k₁ and k₂ for 3 and 4 layer CSI reporting:

TABLE 8

| | | |
|---|---|---|
| N₁ > N₂ > 1 | N₁ = N₂ | N₁ > 2, N₂ = 1 |

| i_{1, 3} | k₁ | k₂ | k₁ | k₂ | k₁ | k₂ |
|---|---|---|---|---|---|---|
| 0 | O₁ | 0 | O₁ | 0 | O₁ | 0 |
| 1 | 0 | O₂ | 0 | O₂ | 2O₁ | 0 |
| 2 | 2O₁ | 0 | 2O₁ | 0 | 3O₁ | 0 |
| 3 | O₁ | O₂ | O₁ | O₂ | 4O₁ | 0 |

Table 8 introduces additional or alternative possibilities for beam selection in layers 3 and 4 based on values of N₁ and N₂ (e.g., horizontally and vertically polarized antenna ports). For example, the UE 115-a may choose a beam for one or more spatially correlated paths based on beam steering in both directions O₁ and O₂ for different values of N₁ and N₂ (e.g., when N₁ and N₂ have the same value or different values). In some implementations, the addition of beam steering in both directions O₁ and O₂ may replace a null first option for beam reporting (e.g., the first option may include zero values for both k₁ and k₂). The addition of beam steering in both directions O₁ and O₂ may also reduce the amount of inter-layer interference by including beam steering in both horizontal and vertical dimensions.

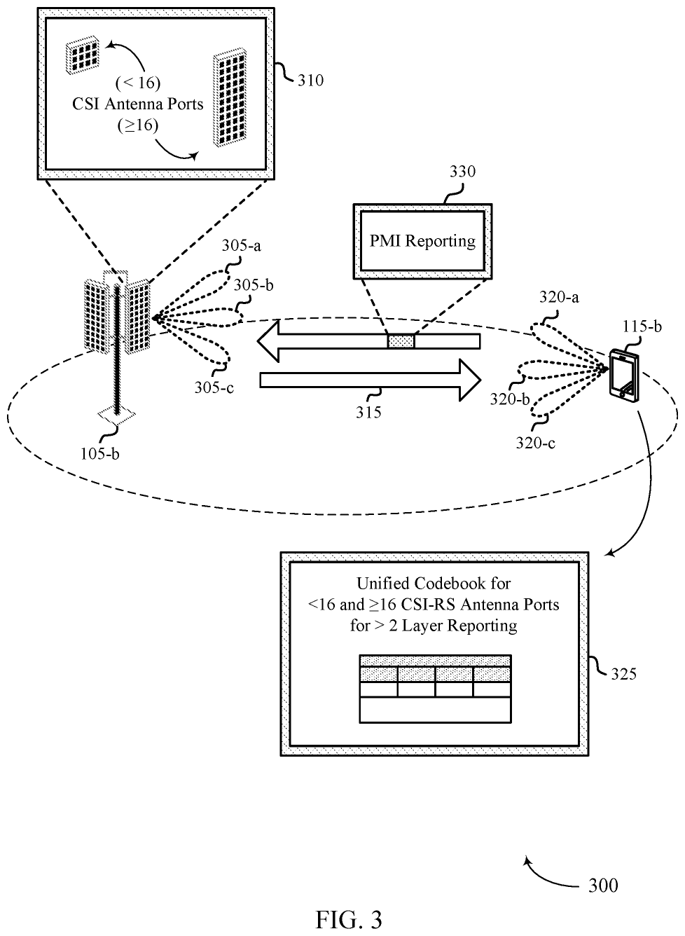

FIG. 3 shows an example of a wireless communications system 300 that supports single antenna panel codebook in accordance with one or more aspects of the present disclosure. For example, the wireless communications system 300 may support communications between a network entity 105-b and a UE 115-b, each of which may be examples of corresponding devices described with reference to FIGS. 1 and 2. In some aspects, the UE 115-b and the network entity 105-b may support CSI measurement and reporting associated with a Type 1 single antenna panel codebook for a plurality of CSI-RS antenna ports at the network entity 105-b, and PMI reporting for a plurality of layers (e.g., for up to 4 layers or more).

The network entity 105-b may output, via the one or more beams (e.g., beam 305-a, beam 305-b, beam 305-c), a set of CSI-RSs via a set of CSI-RS antenna ports 310 for communications 315 with the UE 115-b. The CSI-RSs may allow the UE 115-b to perform one or more measurements (e.g., channel estimation, RSRP, RSRQ, beam directionality measurements, among other measurements) to determine one or more suitable beams with which to communicate with the network entity 105-b. The UE 115-b may receive the set of CSI-RSs via a set of receive beams (e.g., beam 320-a, beam 320-c, beam 320-c-c) and may perform a set of measurements on the CSI-RSs in order to select one or more beams and generate a CSI report to send to the network entity 105-b.

In some examples, the UE 115-b may utilize a Type 1 single antenna panel codebook for Mode 1 in order to select a beam for up to at least 4 layers when the set of CSI-RS antenna ports 310 being equal to either less than 16 CSI-RS antenna ports or greater than or equal to 16 CSI-RS antenna ports. In some implementations, the UE 115-b may use different codebook designs for different threshold quantities of CSI-RS antenna ports, and based on different layers (e.g., different codebooks for less than 16 CSI-RS antenna ports and greater than 16 CSI-RS antenna ports, different codebook designs for 1 and 2 layers versus 3 and 4 layers, or both). For example, when the number of CSI-RS antenna ports is greater than or equal to 16 CSI-RS antenna ports for layers 3 and 4, the codebook may indicate a quantity of beams that are reduced by one half in azimuth, where beams of different layers are fixed relative to the beam of the first layer (e.g., layer 1).

In order to increase the flexibility and reduce the complexity for codebook design and beam selection for layers 3 and 4 when the number of CSI-RS antenna ports is greater than or equal to 16 CSI-RS antenna ports, the UE 115-b may utilize a unified codebook design 325 which is the same for 2 layers (and less than 16 CSI-RS antenna ports) as it is for 3 and 4 layers (and greater than or equal to 16 CSI-RS antenna ports). This unified codebook design 325 may support efficient beam selection for different layers for different quantities of CSI-RS antenna ports, and may unify different designs for Type 1 single antenna panel codebook across the different quantities of CSI-RS antenna ports. For example, the codebook design for 3 layer CSI reporting using antenna ports 3000 to 2999+P_{CSI-RS} may be expressed in Table 9:

TABLE 9
codebookMode = 1

| i_{1,1} | i_{1,2} | i₂ | |
|---|---|---|---|
| 0, . . . , N₁O₁ − 1 | 0, 1, . . . , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 3 )}$ |

$where {W}_{l , {l}^{′} , m , {m}^{′} , n}^{( 3 )} = \frac{1}{\sqrt{3 {P}_{CSI - RS}}} [ \begin{matrix}{v}_{l , m} & {v}_{{l}^{′} , {m}^{′}} & {v}_{l , m} \\ {φ}_{n} {v}_{l , m} & {φ}_{n} {v}_{{l}^{′} , {m}^{′}} & - {φ}_{n} {v}_{l , m}\end{matrix} ]$
and the mapping from i_{1,3} to k₁ and k₂ is given in Table 8.

Where configurable choices for inter-layer dependent beams may be selected from Table 8 described herein, which provides a mapping from i_{1,3} to k₁ and k₂. Additionally, or alternatively, the codebook design for 4 layer CSI reporting using antenna ports 3000 to 2999+P_{CSI-RS} may be expressed in Table 10:

TABLE 10
codebookMode = 1

| i_{1,1} | i_{1,2} | i₂ | |
|---|---|---|---|
| 0, . . . , N₁O₁ − 1 | 0, 1, . . . , N₂O₂ − 1 | 0, 1 | ${W}_{{i}_{1 , 1} , {i}_{1 , 1} + {k}_{1} , {i}_{1 , 2} , {i}_{1 , 2} + {k}_{2} , {i}_{2}}^{( 4 )}$ |

$where {W}_{l , {l}^{′} , m , {m}^{′} , n}^{( 4 )} = \frac{1}{\sqrt{4 {P}_{CSI - RS}}} [ \begin{matrix}{v}_{l , m} & {v}_{{l}^{′} , {m}^{′}} & {v}_{l , m} & {v}_{{l}^{′} , {m}^{′}} \\ {ϕ}_{n} {v}_{l , m} & {ϕ}_{n} {v}_{{l}^{′} , {m}^{′}} & - {ϕ}_{n} {v}_{l , m} & - {ϕ}_{n} {v}_{{l}^{′} , {m}^{′}}\end{matrix} ]$
and the mapping from i_{1,3} to k₁ and k₂ is given in Table 8.

Where configurable choices for inter-layer dependent beams may be selected from Table 8 described herein, which provides a mapping from i_{1,3} to k₁ and k₂.

The UE 115-b may utilize the codebook designs for layers 3 and 4 to select a beam and may report an indication of the selected beam via CSI reporting (including the PMI 330) to the network entity 105-b.

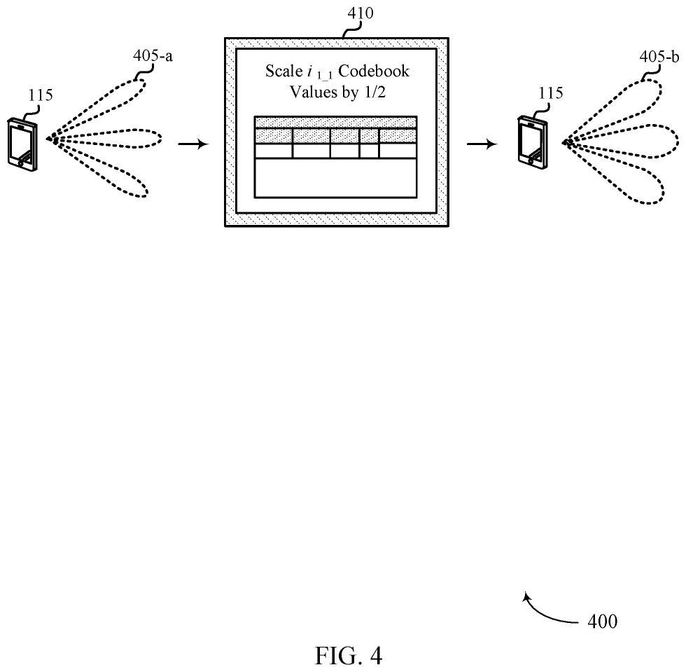

FIG. 4 shows an example of a beam width management configuration 400 that supports single antenna panel codebook in accordance with one or more aspects of the present disclosure. For example, the beam width management configuration 400 may include a UE 115, which may be an example of a UE 115 described with reference to the wireless communications systems of FIGS. 1, 2, and 3. In some aspects, the UE 115 may support CSI measurement and reporting associated with a Type 1 single antenna panel codebook for a plurality of CSI-RS antenna ports at a network entity, and PMI reporting for a plurality of layers (e.g., for layers 3 and 4).

In some implementations, the UE 115 may support a deployment with an increased quantity of CSI-RS antenna ports (e.g., greater than 32 antenna ports) in an azimuthal dimension at the network entity. Such deployments of increased antenna ports may support increased spatial resolution for UEs (e.g., UEs that may be situated, directed, or at least partially overlapping with the azimuthal plane). In some cases, however, horizontal antenna expansion may result in an overly narrow beam (e.g., a beam such as beam 405-a that is overly directional, which may lead to reduced coverage), which may pose challenges for different signal propagation models. In some examples, to maintain a suitably wide beam, the beams may be extended vertically in a zenith dimension (e.g., a vertical dimension), with modifications to the Type 1 single antenna panel codebook to maintain an appropriately wide vertical beam for reporting in layers 3 and 4.

In some aspects, when the number of CSI-RS antenna ports exceeds 16 antenna ports, the available values of i₁ may be reduced to one half to widen the beam 405-a, which may also reduce the reporting overhead associated with the 3 and 4 layer codebooks. Additionally or alternatively, for a quantity of vertical CSI-RS antenna ports exceeding 32 ports (e.g., 64 ports, up to 128 ports or more), the UE 115 may use different codebook designs in order to prevent the beam 405-a from narrowing in the elevation domain, and to reduce the number of candidate DFT beam sets for reporting overhead if the beams are reduced in the elevation domain.

For example, the codebook design may support deployments of greater than 32 CSI-RS antenna ports for layers 3 and 4, where depending on the value of N₂ (e.g., the quantity of vertical antenna ports), the beam size for the beam 405-b may be restricted from becoming narrower in the vertical domain. For example, the UE 115 may implement the codebooks 410 illustrated in Tables 11 and 12 for 3 layer and 4 layer CSI reporting using antenna ports 3000 to 2999+P_{CSI-RS}:

TABLE 11
codebookMode = 1-2, P_{CSI-RS} > 32

| i_{1,1} | i_{1,2} | i_{1,3} | i₂ | |
|---|---|---|---|---|
| 0, . . . , N₁O₁ − 1 | $0 , 1 , … , \frac{{N}_{2} {O}_{2}}{2} - 1$ | 0, 1, 2, 3 | 0, 1 | ${W}_{{i}_{1 , 1} , {i}_{1 , 2} , {i}_{1 , 3} , {i}_{2}}^{( 3 )}$ |

$where {W}_{{i}_{1 , 1} , {i}_{1 , 2} , {i}_{1 , 3} {i}_{2}}^{( 3 )} = \frac{1}{\sqrt{3 {P}_{CSI - RS}}} [ \begin{matrix}{\tilde{v}}_{l , m} & {\tilde{v}}_{l , m} & {\tilde{v}}_{l , m} \\ {θ}_{p} {\tilde{v}}_{l , m} & - {θ}_{p} {\tilde{v}}_{l , m} & {θ}_{p} {\tilde{v}}_{l , m} \\ {φ}_{n} {\tilde{v}}_{l , m} & {φ}_{n} {\tilde{v}}_{l , m} & - {φ}_{n} {\tilde{v}}_{l , m} \\ {φ}_{n} {θ}_{p} {\tilde{v}}_{l , m} & - {φ}_{n} {θ}_{p} {\tilde{v}}_{l , m} & - {φ}_{n} {θ}_{p} {\tilde{v}}_{l , m}\end{matrix} ] .$

In some examples, the available values for i₁₂ for the 3 layer reporting may be reduced to half for any

$${N}_{2} > 1 ( e . g . , \frac{{N}_{2} {O}_{2}}{2} ) ,$$

in order to widen the beam in the vertical domain.

TABLE 12
codebookMode = 1-2, P_{CSI-RS} > 32

| i_{1,1} | i_{1,2} | i_{1,3} | i₂ | |
|---|---|---|---|---|
| 0, . . . , N₁O₁ − 1 | $0 , 1 , … , \frac{{N}_{2} {O}_{2}}{2} - 1$ | 0, 1, 2, 3 | 0, 1 | ${W}_{{i}_{1 , 1} , {i}_{1 , 2} , {i}_{1 , 3} , {i}_{2}}^{( 4 )}$ |

$\begin{matrix}where {W}_{{i}_{1 , 1} , {i}_{1 , 2} , {i}_{1 , 3} {i}_{2}}^{( 4 )} = \\ \frac{\\ 1}{\sqrt{4 {P}_{CSI - RS}}} [ \begin{matrix}{\tilde{v}}_{l , m} & {\tilde{v}}_{l , m} & {\tilde{v}}_{l , m} & - {\tilde{v}}_{l , m} \\ {θ}_{p} {\tilde{v}}_{l , m} & - {θ}_{p} {\tilde{v}}_{l , m} & {θ}_{p} {\tilde{v}}_{l , m} & - {θ}_{p} {\tilde{v}}_{l , m} \\ {φ}_{n} {\tilde{v}}_{l , m} & {φ}_{n} {\tilde{v}}_{l , m} & - {φ}_{n} {\tilde{v}}_{l , m} & - {φ}_{n} {\tilde{v}}_{l , m} \\ {φ}_{n} {θ}_{p} {\tilde{v}}_{l , m} & - {φ}_{n} {θ}_{p} {\tilde{v}}_{l , m} & - {φ}_{n} {θ}_{p} {\tilde{v}}_{l , m} & {φ}_{n} {θ}_{p} {\tilde{v}}_{l , m}\end{matrix} ] .\end{matrix}$

Additionally or alternatively, the available values for i_{1,2} for the 4 layer reporting may be reduced to half for any

$${N}_{2} > 1 ( e . g . , \frac{{N}_{2} {O}_{2}}{2} ) ,$$

in order to widen the beam in the vertical domain.

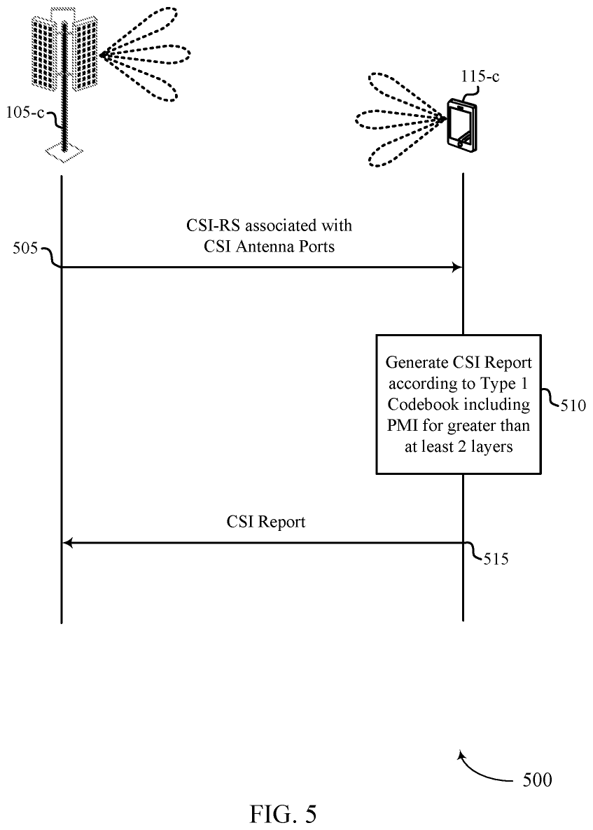

FIG. 5 shows an example of a process flow 500 that supports single antenna panel codebook in accordance with one or more aspects of the present disclosure. The process flow 500 may implement or be implemented by aspects of wireless communications system 100, wireless communications system 200, or wireless communications system 300. For example, the process flow 500 may include a UE 115-c, which may be an example of a UE 115 as described herein. The process flow 500 may also include a network entity 105-c, which may be an example of a network entity 105 as described herein. In the following description of the process flow 500, the communications and processes between the network entity 105-c and the UE 115-c may be performed in a different order than the example order shown, or the communications and processes performed by the network entity 105-c and the UE 115-c may be performed in different orders or at different times. Some operations may also be omitted from the process flow 500, and other operations may be added to the process flow 500. In some examples, the processes performed by the network entity 105-c and the UE 115-c may be performed at different times or by additional or alternative devices.

At 505, the network entity 105-c may transmit, to the UE 115-c, a set of CSI-RSs associated with a plurality of CSI-RS antenna ports at the network entity 105-c. In some implementations, the plurality of CSI-RS antenna ports may include a quantity of more than 16 antenna ports (e.g., 32 CSI-RS antenna ports, up to 128 CSI-RS antenna ports).

At 510, the UE 115-c may generate a CSI report according to a first type of codebook (e.g., a Type 1 codebook), where the CSI report includes an indication of a set of one or more beams associated with a precoding matrix. In some examples, the indication of the set of one or more beams is based on a rank indicator of the precoding matrix being greater than at least two layers (e.g., three layers, four layers), which may correspond to greater than two spatial layers associated with MIMO operation, layers for CSI reporting, a number of columns in a precoding matrix or rank of the precoding matrix.

In some examples, the CSI report may include a plurality of bits for each subband precoder of the first type of codebook, where the rank indicator is for three layer or four layers. In some examples, the indication of the set of one or more beams associated with the precoding matrix includes a first quantity of beams for wideband and a second quantity of beams for subband. In such examples, the first quantity of beams for wideband may be adjusted by one half for the rank indicator of three layers or four layers based on the plurality of bits for each subband precoder of the first type of codebook. In some aspects, the first quantity of beams for wideband are based on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

In some examples, the indication of the set of one or more beams is based on a scaling factor of one over a square root of a quantity of three times a value of the plurality of CSI antenna ports. Additionally or alternatively, the indication of the set of one or more beams may be based on a scaling factor of one over a square root of a quantity of four times a value of the plurality of CSI-RS antenna ports.

In some implementations, the plurality of CSI-RS antenna ports at the network entity 105-c may be greater than 32 CSI-RS antenna ports, and the UE 115-c may select at least one beam of the set of one or more beams such that a direction of the at least one beam is based on a pair of DFT oversampling factors selected from a set of DFT oversampling factor pairs. In some cases, at least one DFT oversampling pair includes both a first DFT oversampling factor associated with a vertical antenna polarization and a second DFT oversampling factor associated with a horizontal antenna polarization. In some aspects, the at least one DFT oversampling pair includes both a first DFT oversampling factor associated with a vertical antenna polarization and a second DFT oversampling factor associated with a horizontal antenna polarization. In some aspects, the first DFT oversampling factor associated with the vertical antenna polarization and the second DFT oversampling factor associated with the horizontal antenna polarization are indicative of the at least one beam in both a vertical dimension and a horizontal dimension.

In some implementations, the plurality of CSI-RS antenna ports at the network entity 105-c may be greater than 16 CSI-RS antenna ports, and the UE 115-c may select at least one beam of the set of one or more beams in accordance with a unified codebook associated with the at least two layers of the precoding matrix. In some cases, the at least two layers of the precoding matrix includes two layers, three layers, four layers, or any combination thereof. In some aspects, the set of one or more beams is based on a set of respective vertically polarized antenna ports multiplied by respective DFT oversampling factors in a vertical dimension and a set of respective horizontally polarized antenna ports multiplied by respective DFT oversampling factors in a horizontal dimension.

In some implementations, the plurality of CSI-RS antenna ports includes at least 32 CSI-RS antenna ports, and the rank indicator associated with the precoding matrix is three layers or four layers. In some such implementations, a quantity of available beam values for a vertical dimension is adjusted by one half (e.g., relative to a quantity of available beam values for a horizontal dimension) for quantities of vertically polarized antenna ports greater than one. In some examples, the adjustment of beams in the vertical dimension may widen the beams (e.g., via reduction in an elevation dimension).

At 515, the UE 115-c may transmit the CSI report to the network entity 105-c.

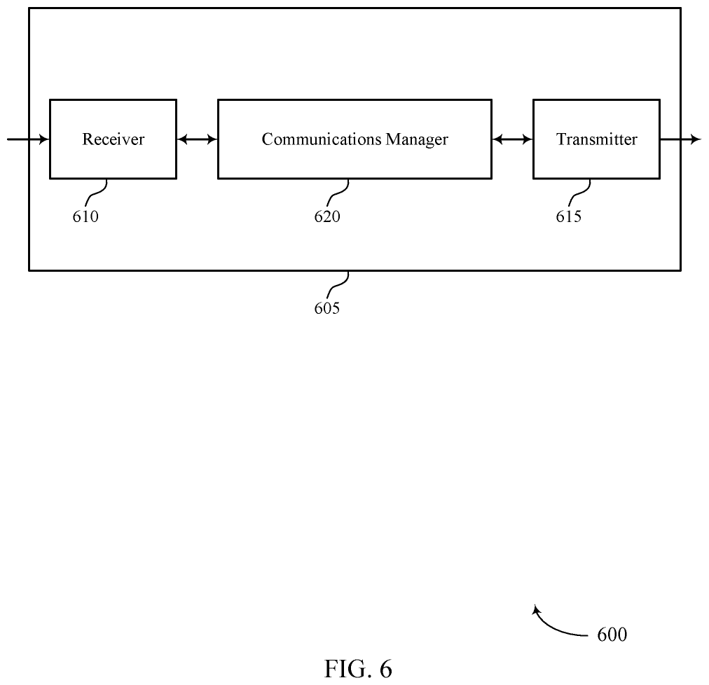

FIG. 6 shows a block diagram 600 of a device 605 that supports single antenna panel codebook in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to single antenna panel codebook). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to single antenna panel codebook). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of single antenna panel codebook as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, from a network entity, a set of CSI-RSs associated with a set of multiple CSI-RS antenna ports. The communications manager 620 is capable of, configured to, or operable to support a means for generating a CSI report according to a first type of codebook, where the CSI report includes an indication of a set of one or more beams associated with a precoding matrix, and where the indication of the set of one or more beams is based on a rank indicator being greater than at least two layers. The communications manager 620 is capable of, configured to, or operable to support a means for transmitting the CSI report to the network entity.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources, increased accuracy for beamforming, enhanced CSI-RS measurement and reporting, and increased coverage.

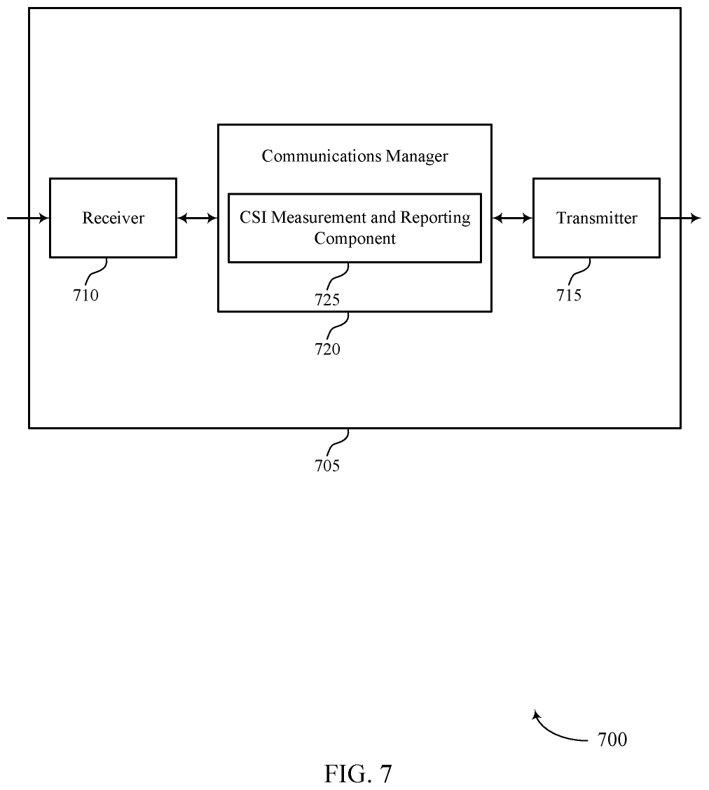

FIG. 7 shows a block diagram 700 of a device 705 that supports single antenna panel codebook in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to single antenna panel codebook). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to single antenna panel codebook). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of single antenna panel codebook as described herein. For example, the communications manager 720 may include a CSI measurement and reporting component 725, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The CSI measurement and reporting component 725 is capable of, configured to, or operable to support a means for receiving, from a network entity, a set of CSI-RSs associated with a set of multiple CSI-RS antenna ports. The CSI measurement and reporting component 725 is capable of, configured to, or operable to support a means for generating a CSI report according to a first type of codebook, where the CSI report includes an indication of a set of one or more beams associated with a precoding matrix, and where the indication of the set of one or more beams is based on a rank indicator being greater than at least two layers. The CSI measurement and reporting component 725 is capable of, configured to, or operable to support a means for transmitting the CSI report to the network entity.

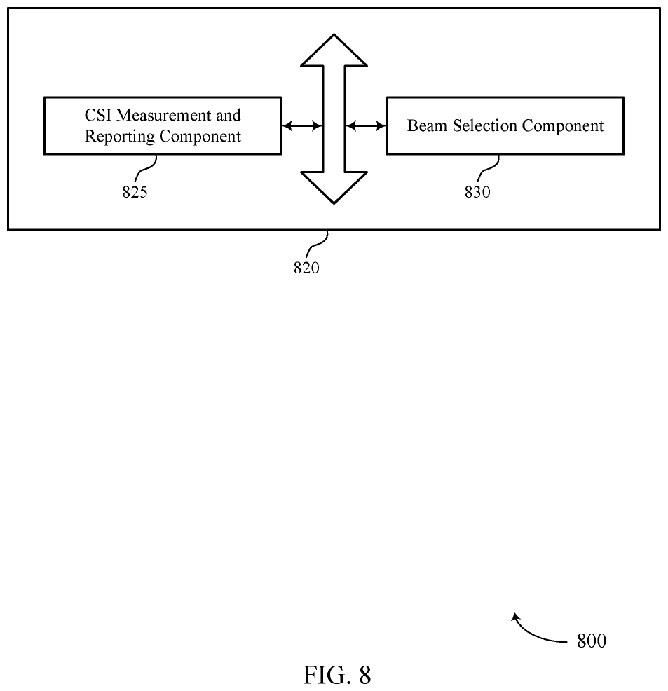

FIG. 8 shows a block diagram 800 of a communications manager 820 that supports single antenna panel codebook in accordance with one or more aspects of the present disclosure. The communications manager 820 may be an example of aspects of a communications manager 620, a communications manager 720, or both, as described herein. The communications manager 820, or various components thereof, may be an example of means for performing various aspects of single antenna panel codebook as described herein. For example, the communications manager 820 may include a CSI measurement and reporting component 825 a beam selection component 830, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The CSI measurement and reporting component 825 is capable of, configured to, or operable to support a means for receiving, from a network entity, a set of CSI-RSs associated with a set of multiple CSI-RS antenna ports. In some examples, the CSI measurement and reporting component 825 is capable of, configured to, or operable to support a means for generating a CSI report according to a first type of codebook, where the CSI report includes an indication of a set of one or more beams associated with a precoding matrix, and where the indication of the set of one or more beams is based on a rank indicator being greater than at least two layers. In some examples, the CSI measurement and reporting component 825 is capable of, configured to, or operable to support a means for transmitting the CSI report to the network entity.

In some examples, the CSI report includes a set of multiple bits for each subband precoder of the first type of codebook. In some examples, the rank indicator includes three layers or four layers. In some examples, the indication of the set of one or more beams associated with the precoding matrix includes a first quantity of beams for wideband and a second quantity of beams for subband. In some examples, the first quantity of beams for wideband are adjusted by one half for the rank indicator of three layers or four layers based on the set of multiple bits for each subband precoder of the first type of codebook.

In some examples, the first quantity of beams for wideband are based on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

In some examples, the indication of the set of one or more beams is based on a scaling factor of one over a square root of a quantity of three times a value of the set of multiple CSI-RS antenna ports. In some examples, the indication of the set of one or more beams is based on a scaling factor of one over a square root of a quantity of four times a value of the set of multiple CSI-RS antenna ports.

In some examples, the set of multiple CSI-RS antenna ports includes a quantity that is greater than 32 CSI-RS antenna ports, and the beam selection component 830 is capable of, configured to, or operable to support a means for selecting at least one beam of the set of one or more beams, where a direction of the at least one beam is based on a pair of DFT oversampling factors selected from a set of DFT oversampling factor pairs, and where at least one DFT oversampling pair includes both a first DFT oversampling factor associated with a vertical antenna polarization and a second DFT oversampling factor associated with a horizontal antenna polarization.

In some examples, the set of DFT oversampling factor pairs lacks a DFT oversampling pair including a zero value for both the first DFT oversampling factor associated with the vertical antenna polarization and the second DFT oversampling factor associated with the horizontal antenna polarization. In some examples, the first DFT oversampling factor associated with the vertical antenna polarization and the second DFT oversampling factor associated with the horizontal antenna polarization are indicative of the at least one beam in both a vertical dimension and a horizontal dimension.

In some examples, the set of multiple CSI-RS antenna ports include greater than 16 CSI-RS antenna ports, and the beam selection component 830 is capable of, configured to, or operable to support a means for selecting at least one beam of the set of one or more beams in accordance with a unified codebook associated with the at least two layers of the precoding matrix, where the at least two layers of the precoding matrix include two layers, three layers, four layers, or any combination thereof.

In some examples, the set of one or more beams is based on a set of respective vertically polarized antenna ports multiplied by respective DFT oversampling factors in a vertical dimension and a set of respective horizontally polarized antenna ports multiplied by respective DFT oversampling factors in a horizontal dimension.

In some examples, the set of multiple CSI-RS antenna ports include at least 32 CSI-RS antenna ports and the rank indicator includes three layers or four layers. In some examples, a quantity of available beam values for a vertical dimension is adjusted by one half for quantities of vertically polarized antenna ports greater than one.

In some examples, a quantity of available beam values for the vertical dimension is adjusted by one half relative to a quantity of available beam values for a horizontal dimension. In some examples, the set of multiple CSI-RS antenna ports includes a quantity that is greater than 32 CSI-RS antenna ports.

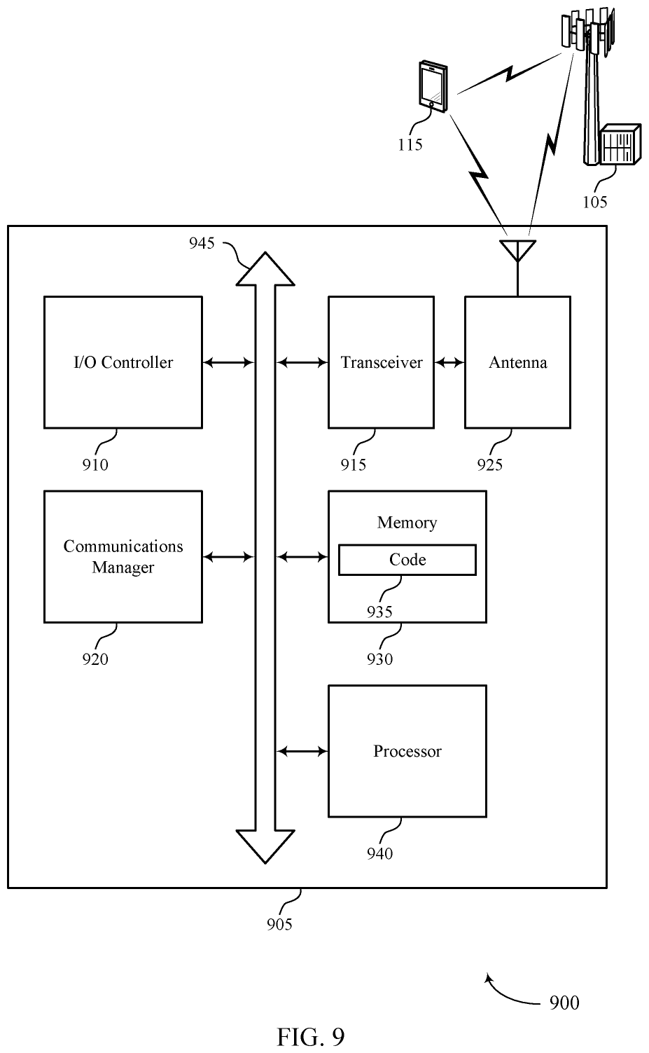

FIG. 9 shows a diagram of a system 900 including a device 905 that supports single antenna panel codebook in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting single antenna panel codebook). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, from a network entity, a set of CSI-RSs associated with a set of multiple CSI-RS antenna ports. The communications manager 920 is capable of, configured to, or operable to support a means for generating a CSI report according to a first type of codebook, where the CSI report includes an indication of a set of one or more beams associated with a precoding matrix, and where the indication of the set of one or more beams is based on a rank indicator being greater than at least two layers. The communications manager 920 is capable of, configured to, or operable to support a means for transmitting the CSI report to the network entity.

By including or configuring the communications manager 920 in accordance with examples as described herein, the device 905 may support techniques for improved communication reliability, reduced latency, more efficient utilization of communication resources, improved coordination between devices, improved utilization of processing capability, improved beamforming and beam selection accuracy, increased communications quality, higher throughput and spectral efficiency, and improved efficiency for codebook based communications.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of single antenna panel codebook as described herein, or the at least one processor 940 and the at least one memory 930 may be otherwise configured to, individually or collectively, perform or support such operations.

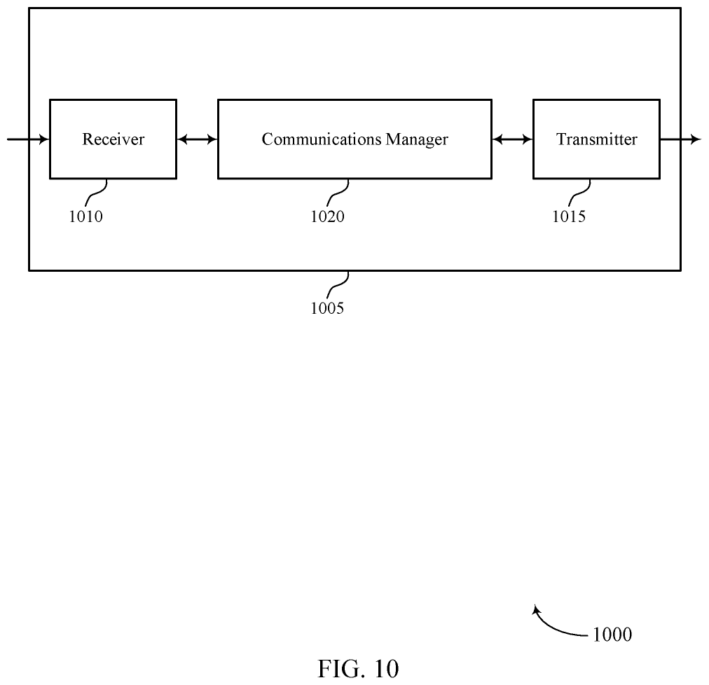

FIG. 10 shows a block diagram 1000 of a device 1005 that supports single antenna panel codebook in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of single antenna panel codebook as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting a set of CSI-RSs via a set of multiple CSI-RS antenna ports at the network entity. The communications manager 1020 is capable of, configured to, or operable to support a means for receiving a CSI report according to a first type of codebook, where the CSI report includes an indication of a set of one or more beams associated with a precoding matrix, and where the indication of the set of one or more beams is based on a rank indicator being greater than at least two layers.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources, increased accuracy for beamforming, enhanced CSI-RS measurement and reporting, and increased coverage.

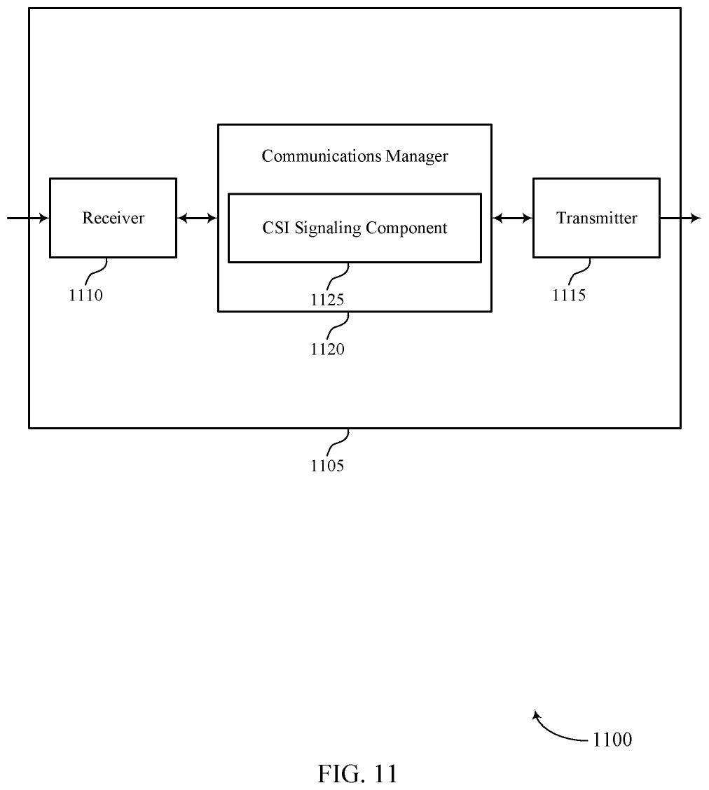

FIG. 11 shows a block diagram 1100 of a device 1105 that supports single antenna panel codebook in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of single antenna panel codebook as described herein. For example, the communications manager 1120 may include a CSI signaling component 1125, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The CSI signaling component 1125 is capable of, configured to, or operable to support a means for outputting a set of CSI-RSs via a set of multiple CSI-RS antenna ports at the network entity. The CSI signaling component 1125 is capable of, configured to, or operable to support a means for receiving a CSI report according to a first type of codebook, where the CSI report includes an indication of a set of one or more beams associated with a precoding matrix, and where the indication of the set of one or more beams is based on a rank indicator being greater than at least two layers.

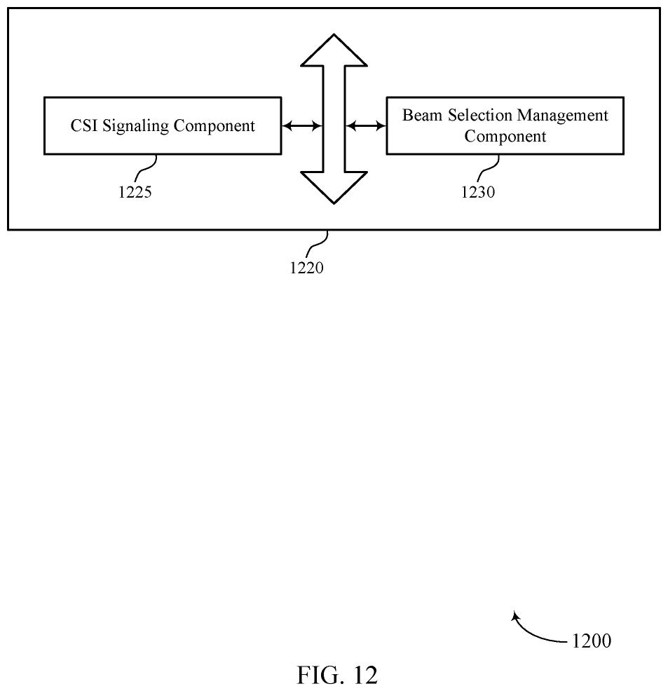

FIG. 12 shows a block diagram 1200 of a communications manager 1220 that supports single antenna panel codebook in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of single antenna panel codebook as described herein. For example, the communications manager 1220 may include a CSI signaling component 1225 a beam selection management component 1230, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The CSI signaling component 1225 is capable of, configured to, or operable to support a means for outputting a set of CSI-RSs via a set of multiple CSI-RS antenna ports at the network entity. In some examples, the CSI signaling component 1225 is capable of, configured to, or operable to support a means for receiving a CSI report according to a first type of codebook, where the CSI report includes an indication of a set of one or more beams associated with a precoding matrix, and where the indication of the set of one or more beams is based on a rank indicator being greater than at least two layers.

In some examples, the CSI report includes a set of multiple bits for each subband precoder of the first type of codebook. In some examples, the rank indicator includes three layers or four layers.

In some examples, the indication of the set of one or more beams associated with the precoding matrix includes a first quantity of beams for wideband and a second quantity of beams for subband. In some examples, the first quantity of beams for wideband are adjusted by one half for the rank indicator of three layers or four layers based on the set of multiple bits for each subband precoder of the first type of codebook.

In some examples, the first quantity of beams for wideband are based on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

In some examples, the indication of the set of one or more beams is based on a scaling factor of one over a square root of a quantity of three times a value of the set of multiple CSI-RS antenna ports.

In some examples, the indication of the set of one or more beams is based on a scaling factor of one over a square root of a quantity of four times a value of the set of multiple CSI-RS antenna ports.

In some examples, the set of multiple CSI-RS antenna ports includes a quantity that is greater than 32 CSI-RS antenna ports, and the beam selection management component 1230 is capable of, configured to, or operable to support a means for receiving an indication of a selection of at least one beam of the set of one or more beams, where a direction of the at least one beam is based on a pair of DFT oversampling factors selected from a set of DFT oversampling factor pairs, and where at least one DFT oversampling pair includes both a first DFT oversampling factor associated with a vertical antenna polarization and a second DFT oversampling factor associated with a horizontal antenna polarization.

In some examples, the set of DFT oversampling factor pairs lacks a DFT oversampling pair including a zero value for both the first DFT oversampling factor associated with the vertical antenna polarization and the second DFT oversampling factor associated with the horizontal antenna polarization.

In some examples, the first DFT oversampling factor associated with the vertical antenna polarization and the second DFT oversampling factor associated with the horizontal antenna polarization are indicative of the at least one beam in both a vertical dimension and a horizontal dimension.

In some examples, the set of multiple CSI-RS antenna ports include greater than 16 CSI-RS antenna ports, and the beam selection management component 1230 is capable of, configured to, or operable to support a means for obtaining an indication of a selection of at least one beam of the set of one or more beams in accordance with a unified codebook associated with the at least two layers of the precoding matrix, where the at least two layers of the precoding matrix include two layers, three layers, four layers, or any combination thereof.

In some examples, the set of one or more beams is based on a set of respective vertically polarized antenna ports multiplied by respective DFT oversampling factors in a vertical dimension and a set of respective horizontally polarized antenna ports multiplied by respective DFT oversampling factors in a horizontal dimension.

In some examples, the set of multiple CSI-RS antenna ports include at least 32 CSI-RS antenna ports and the rank indicator includes three layers or four layers. In some examples, a quantity of available beam values for a vertical dimension is adjusted by one half for quantities of vertically polarized antenna ports greater than one.

In some examples, a quantity of available beam values for the vertical dimension is adjusted by one half relative to a quantity of available beam values for a horizontal dimension.

In some examples, the set of multiple CSI-RS antenna ports includes a quantity that is greater than 32 CSI-RS antenna ports.

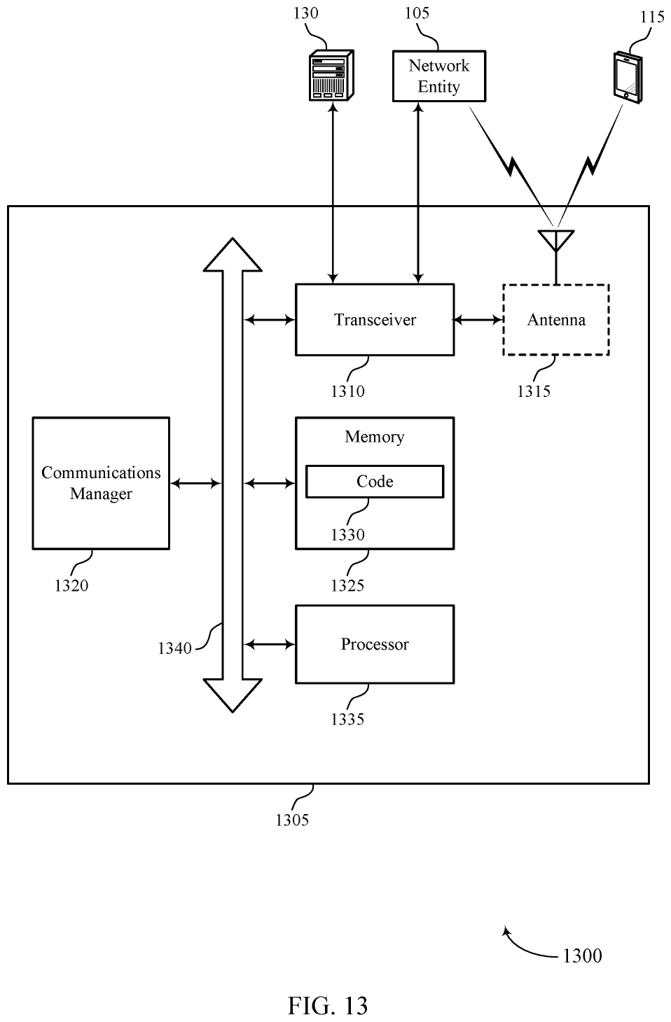

FIG. 13 shows a diagram of a system 1300 including a device 1305 that supports single antenna panel codebook in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting single antenna panel codebook). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting a set of CSI-RSs via a set of multiple CSI-RS antenna ports at the network entity. The communications manager 1320 is capable of, configured to, or operable to support a means for receiving a CSI report according to a first type of codebook, where the CSI report includes an indication of a set of one or more beams associated with a precoding matrix, and where the indication of the set of one or more beams is based on a rank indicator being greater than at least two layers.

By including or configuring the communications manager 1320 in accordance with examples as described herein, the device 1305 may support techniques for improved communication reliability, reduced latency, more efficient utilization of communication resources, improved coordination between devices, improved utilization of processing capability, improved beamforming and beam selection accuracy, increased communications quality, higher throughput and spectral efficiency, and improved efficiency for codebook based communications.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of single antenna panel codebook as described herein, or the at least one processor 1335 and the at least one memory 1325 may be otherwise configured to, individually or collectively, perform or support such operations.

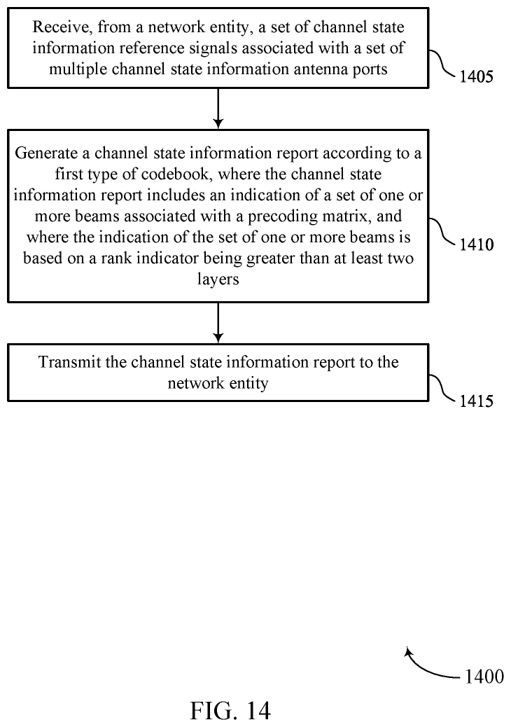

FIG. 14 shows a flowchart illustrating a method 1400 that supports single antenna panel codebook in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a set of CSI-RSs associated with a set of multiple CSI-RS antenna ports. The operations of 1405 may be performed in accordance with examples as disclosed herein. In some examples, aspects of the operations of 1405 may be performed by a CSI measurement and reporting component 825 as described with reference to FIG. 8. In some aspects, the set of CSI-RSs may be received via one or more receive beams (e.g., beam 220-a, beam 220-b, beam 220-c, beam 320-a, beam 320-b, beam 320-c) described with reference to FIGS. 2 and 3.

At 1410, the method may include generating a CSI report according to a first type of codebook, where the CSI report includes an indication of a set of one or more beams associated with a precoding matrix, and where the indication of the set of one or more beams is based on a rank indicator being greater than at least two layers. The operations of 1410 may be performed in accordance with examples as disclosed herein. In some examples, aspects of the operations of 1410 may be performed by a CSI measurement and reporting component 825 as described with reference to FIG. 8. In some aspects, the CSI report may be generated by UEs 115 described with reference to FIGS. 1, 2, 3, 4, and 5. In some aspects, the CSI report may include the PMI 240 or the PMI 330 described with reference to FIGS. 2 and 3.

At 1415, the method may include transmitting the CSI report to the network entity. The operations of 1415 may be performed in accordance with examples as disclosed herein. In some examples, aspects of the operations of 1415 may be performed by a CSI measurement and reporting component 825 as described with reference to FIG. 8. In some aspects, a UE 115 may transmit the CSI report via the PMI 240 or the PMI 330 described with reference to FIGS. 2 and 3.

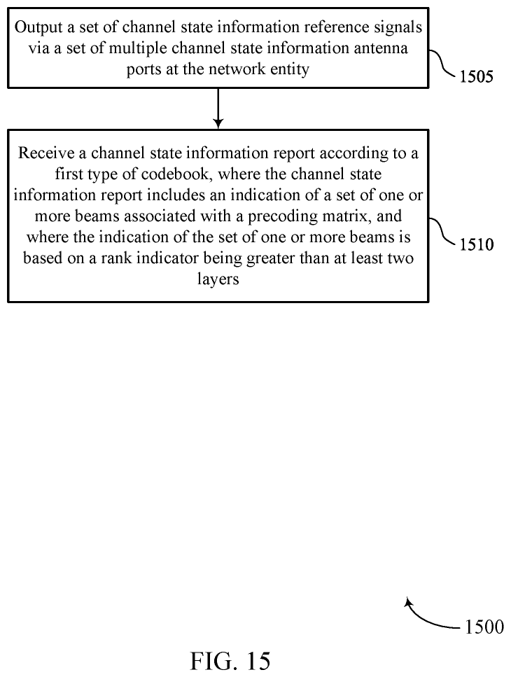

FIG. 15 shows a flowchart illustrating a method 1500 that supports single antenna panel codebook in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting a set of CSI-RSs via a set of multiple CSI-RS antenna ports at the network entity. The operations of 1505 may be performed in accordance with examples as disclosed herein. In some examples, aspects of the operations of 1505 may be performed by a CSI signaling component 1225 as described with reference to FIG. 12. In some aspects, the set of CSI-RSs may be output via one or more transmit beams (e.g., beam 205-a, beam 205-b, beam 205-c, beam 305-a, beam 305-b, beam 305-c) described with reference to FIGS. 2 and 3.

At 1510, the method may include receiving a CSI report according to a first type of codebook, where the CSI report includes an indication of a set of one or more beams associated with a precoding matrix, and where the indication of the set of one or more beams is based on a rank indicator being greater than at least two layers. The operations of 1510 may be performed in accordance with examples as disclosed herein. In some examples, aspects of the operations of 1510 may be performed by a CSI signaling component 1225 as described with reference to FIG. 12. In some aspects, the CSI report may be received via beam 205-a, beam 205-b, beam 205-c, beam 305-a, beam 305-b, or beam 305-c described with reference to FIGS. 2 and 3. In some aspects the CSI report may be received via the PMI 240 or the PMI 330 described with reference to FIGS. 2 and 3.

The following provides an overview of aspects of the present disclosure:

Aspect 1: A method for wireless communications at a UE, comprising: receiving, from a network entity, a set of CSI-RSs associated with a plurality of CSI antenna ports; generating a CSI report according to a first type of codebook, wherein the CSI report includes an indication of a set of one or more beams associated with a precoding matrix, and wherein the indication of the set of one or more beams is based at least in part on a rank indicator being greater than at least two layers; and transmitting the CSI report to the network entity.

Aspect 2: The method of aspect 1, wherein the CSI report comprises a plurality of bits for each subband precoder of the first type of codebook, and the rank indicator comprises three layers or four layers.

Aspect 3: The method of aspect 2, wherein the indication of the set of one or more beams associated with the precoding matrix comprises a first quantity of beams for wideband and a second quantity of beams for subband, and the first quantity of beams for wideband are adjusted by one half for the rank indicator of three layers or four layers based at least in part on the plurality of bits for each subband precoder of the first type of codebook.

Aspect 4: The method of aspect 3, wherein the first quantity of beams for wideband are based at least in part on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

Aspect 5: The method of any of aspects 2 through 4, wherein the indication of the set of one or more beams is based at least in part on a scaling factor of one over a square root of a quantity of three times a value of the plurality of CSI antenna ports.

Aspect 6: The method of any of aspects 2 through 5, wherein the indication of the set of one or more beams is based at least in part on a scaling factor of one over a square root of a quantity of four times a value of the plurality of CSI antenna ports.

Aspect 7: The method of any of aspects 1 through 6, wherein the plurality of CSI antenna ports comprises a quantity that is greater than 32 CSI antenna ports, the method further comprising: selecting at least one beam of the set of one or more beams, wherein a direction of the at least one beam is based at least in part on a pair of DFT oversampling factors selected from a set of DFT oversampling factor pairs, and wherein at least one DFT oversampling pair comprises both a first DFT oversampling factor associated with a vertical antenna polarization and a second DFT oversampling factor associated with a horizontal antenna polarization.

Aspect 8: The method of aspect 7, wherein the set of DFT oversampling factor pairs lacks a DFT oversampling pair comprising a zero value for both the first DFT oversampling factor associated with the vertical antenna polarization and the second DFT oversampling factor associated with the horizontal antenna polarization.

Aspect 9: The method of any of aspects 7 through 8, wherein the first DFT oversampling factor associated with the vertical antenna polarization and the second DFT oversampling factor associated with the horizontal antenna polarization are indicative of the at least one beam in both a vertical dimension and a horizontal dimension.

Aspect 10: The method of any of aspects 1 through 9, wherein the plurality of CSI antenna ports comprise greater than 16 CSI antenna ports, the method further comprising: selecting at least one beam of the set of one or more beams in accordance with a unified codebook associated with the at least two layers of the precoding matrix, wherein the at least two layers of the precoding matrix comprise two layers, three layers, four layers, or any combination thereof.

Aspect 11: The method of aspect 10, wherein the set of one or more beams is based at least in part on a set of respective vertically polarized antenna ports multiplied by respective DFT oversampling factors in a vertical dimension and a set of respective horizontally polarized antenna ports multiplied by respective DFT oversampling factors in a horizontal dimension.

Aspect 12: The method of any of aspects 1 through 11, wherein the plurality of CSI antenna ports comprise at least 32 CSI antenna ports and the rank indicator comprises three layers or four layers, and a quantity of available beam values for a vertical dimension is adjusted by one half for quantities of vertically polarized antenna ports greater than one.

Aspect 13: The method of aspect 12, wherein a quantity of available beam values for the vertical dimension is adjusted by one half relative to a quantity of available beam values for a horizontal dimension.

Aspect 14: The method of any of aspects 1 through 13, wherein the plurality of CSI antenna ports comprises a quantity that is greater than 32 CSI antenna ports.

Aspect 15: A method for wireless communications at a network entity, comprising: outputting a set of CSI-RSs via a plurality of CSI antenna ports at the network entity; and receiving a CSI report according to a first type of codebook, wherein the CSI report includes an indication of a set of one or more beams associated with a precoding matrix, and wherein the indication of the set of one or more beams is based at least in part on a rank indicator being greater than at least two layers.

Aspect 16: The method of aspect 15, wherein the CSI report comprises a plurality of bits for each subband precoder of the first type of codebook, and the rank indicator comprises three layers or four layers.

Aspect 17: The method of aspect 16, wherein the indication of the set of one or more beams associated with the precoding matrix comprises a first quantity of beams for wideband and a second quantity of beams for subband, and the first quantity of beams for wideband are adjusted by one half for the rank indicator of three layers or four layers based at least in part on the plurality of bits for each subband precoder of the first type of codebook.

Aspect 18: The method of aspect 17, wherein the first quantity of beams for wideband are based at least in part on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

Aspect 19: The method of any of aspects 16 through 18, wherein the indication of the set of one or more beams is based at least in part on a scaling factor of one over a square root of a quantity of three times a value of the plurality of CSI antenna ports.

Aspect 20: The method of any of aspects 16 through 19, wherein the indication of the set of one or more beams is based at least in part on a scaling factor of one over a square root of a quantity of four times a value of the plurality of CSI antenna ports.

Aspect 21: The method of any of aspects 15 through 20, wherein the plurality of CSI antenna ports comprises a quantity that is greater than 32 CSI antenna ports, the method further comprising: receiving an indication of a selection of at least one beam of the set of one or more beams, wherein a direction of the at least one beam is based at least in part on a pair of DFT oversampling factors selected from a set of DFT oversampling factor pairs, and wherein at least one DFT oversampling pair comprises both a first DFT oversampling factor associated with a vertical antenna polarization and a second DFT oversampling factor associated with a horizontal antenna polarization.

Aspect 22: The method of aspect 21, wherein the set of DFT oversampling factor pairs lacks a DFT oversampling pair comprising a zero value for both the first DFT oversampling factor associated with the vertical antenna polarization and the second DFT oversampling factor associated with the horizontal antenna polarization.

Aspect 23: The method of any of aspects 21 through 22, wherein the first DFT oversampling factor associated with the vertical antenna polarization and the second DFT oversampling factor associated with the horizontal antenna polarization are indicative of the at least one beam in both a vertical dimension and a horizontal dimension.

Aspect 24: The method of any of aspects 15 through 23, wherein the plurality of CSI antenna ports comprise greater than 16 CSI antenna ports, the method further comprising: obtaining an indication of a selection of at least one beam of the set of one or more beams in accordance with a unified codebook associated with the at least two layers of the precoding matrix, wherein the at least two layers of the precoding matrix comprise two layers, three layers, four layers, or any combination thereof.

Aspect 25: The method of aspect 24, wherein the set of one or more beams is based at least in part on a set of respective vertically polarized antenna ports multiplied by respective DFT oversampling factors in a vertical dimension and a set of respective horizontally polarized antenna ports multiplied by respective DFT oversampling factors in a horizontal dimension.

Aspect 26: The method of any of aspects 15 through 25, wherein the plurality of CSI antenna ports comprise at least 32 CSI antenna ports and the rank indicator comprises three layers or four layers, and a quantity of available beam values for a vertical dimension is adjusted by one half for quantities of vertically polarized antenna ports greater than one.

Aspect 27: The method of aspect 26, wherein a quantity of available beam values for the vertical dimension is adjusted by one half relative to a quantity of available beam values for a horizontal dimension.

Aspect 28: The method of any of aspects 15 through 27, wherein the plurality of CSI antenna ports comprises a quantity that is greater than 32 CSI antenna ports.

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a set of channel state information reference signals associated with a plurality of channel state information-reference signal antenna ports;
generate a channel state information report according to a first type of codebook, wherein the channel state information report includes an indication of a set of one or more beams associated with a precoding matrix, and wherein the indication of the set of one or more beams is based at least in part on a rank indicator being greater than at least two layers; and
transmit the channel state information report to the network entity.

2. The UE of claim 1, wherein the channel state information report comprises a plurality of bits for each subband precoder of the first type of codebook, and the rank indicator comprises three layers or four layers.

3. The UE of claim 2, wherein the indication of the set of one or more beams associated with the precoding matrix comprises a first quantity of beams for wideband and a second quantity of beams for subband, and the first quantity of beams for wideband are adjusted by one half for the rank indicator of three layers or four layers based at least in part on the plurality of bits for each subband precoder of the first type of codebook.

4. The UE of claim 3, wherein the first quantity of beams for wideband are based at least in part on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

5. The UE of claim 2, wherein the indication of the set of one or more beams is based at least in part on a scaling factor of one over a square root of a quantity of three times a value of the plurality of channel state information-reference signal antenna ports.

6. The UE of claim 2, wherein the indication of the set of one or more beams is based at least in part on a scaling factor of one over a square root of a quantity of four times a value of the plurality of channel state information-reference signal antenna ports.

7. The UE of claim 1, wherein the plurality of channel state information-reference signal antenna ports comprises a quantity that is greater than 32 channel state information-reference signal antenna ports, and the one or more processors are individually or collectively further operable to execute the code to cause the UE to:
select at least one beam of the set of one or more beams,
wherein a direction of the at least one beam is based at least in part on a pair of discrete Fourier transform (DFT) oversampling factors selected from a set of DFT oversampling factor pairs, and
wherein at least one DFT oversampling pair comprises both a first DFT oversampling factor associated with a vertical antenna polarization and a second DFT oversampling factor associated with a horizontal antenna polarization.

8. The UE of claim 7, wherein the set of DFT oversampling factor pairs lacks a DFT oversampling pair comprising a zero value for both the first DFT oversampling factor associated with the vertical antenna polarization and the second DFT oversampling factor associated with the horizontal antenna polarization.

9. The UE of claim 7, wherein the first DFT oversampling factor associated with the vertical antenna polarization and the second DFT oversampling factor associated with the horizontal antenna polarization are indicative of the at least one beam in both a vertical dimension and a horizontal dimension.

10. The UE of claim 1, wherein the plurality of channel state information-reference signal antenna ports comprise greater than 16 channel state information-reference signal antenna ports, and the one or more processors are individually or collectively further operable to execute the code to cause the UE to:
select at least one beam of the set of one or more beams in accordance with a unified codebook associated with the at least two layers of the precoding matrix,
wherein the at least two layers of the precoding matrix comprise two layers, three layers, four layers, or any combination thereof.

11. The UE of claim 10, wherein the set of one or more beams is based at least in part on a set of respective vertically polarized antenna ports multiplied by respective discrete Fourier transform (DFT) oversampling factors in a vertical dimension and a set of respective horizontally polarized antenna ports multiplied by respective DFT oversampling factors in a horizontal dimension.

12. The UE of claim 1, wherein the plurality of channel state information-reference signal antenna ports comprise at least 32 channel state information-reference signal antenna ports and the rank indicator comprises three layers or four layers, and a quantity of available beam values for a vertical dimension is adjusted by one half for quantities of vertically polarized antenna ports greater than one.

13. The UE of claim 12, wherein the quantity of available beam values for the vertical dimension is adjusted by one half relative to the quantity of available beam values for a horizontal dimension.

14. The UE of claim 1, wherein the plurality of channel state information-reference signal antenna ports comprises a quantity that is greater than 32 channel state information-reference signal antenna ports.

15. A network entity, comprising:
one or more memories storing processor-executable code; and
one or more processors coupled with the one or more memories and individually or collectively operable to execute the code to cause the network entity to:
output a set of channel state information reference signals via a plurality of channel state information-reference signal antenna ports at the network entity; and
receive a channel state information report according to a first type of codebook, wherein the channel state information report includes an indication of a set of one or more beams associated with a precoding matrix, and wherein the indication of the set of one or more beams is based at least in part on a rank indicator being greater than at least two layers.

16. The network entity of claim 15, wherein the channel state information report comprises a plurality of bits for each subband precoder of the first type of codebook, and the rank indicator comprises three layers or four layers.

17. The network entity of claim 16, wherein the indication of the set of one or more beams associated with the precoding matrix comprises a first quantity of beams for wideband and a second quantity of beams for subband, and the first quantity of beams for wideband are adjusted by one half for the rank indicator of three layers or four layers based at least in part on the plurality of bits for each subband precoder of the first type of codebook.

18. The network entity of claim 17, wherein the first quantity of beams for wideband are based at least in part on one half of a quantity of horizontally polarized antenna ports multiplied by a corresponding quantity of horizontal beam oversampling factors, one half of a quantity of vertically polarized antenna ports multiplied by a corresponding quantity of vertical beam oversampling factors, or both.

19. The network entity of claim 16, wherein the indication of the set of one or more beams is based at least in part on a scaling factor of one over a square root of a quantity of three times a value of the plurality of channel state information-reference signal antenna ports.

20. The network entity of claim 16, wherein the indication of the set of one or more beams is based at least in part on a scaling factor of one over a square root of a quantity of four times a value of the plurality of channel state information-reference signal antenna ports.

21. The network entity of claim 15, wherein the plurality of channel state information-reference signal antenna ports comprises a quantity that is greater than 32 channel state information-reference signal antenna ports, and the one or more processors are individually or collectively further operable to execute the code to cause the network entity to:
receive an indication of a selection of at least one beam of the set of one or more beams,
wherein a direction of the at least one beam is based at least in part on a pair of discrete Fourier transform (DFT) oversampling factors selected from a set of DFT oversampling factor pairs, and
wherein at least one DFT oversampling pair comprises both a first DFT oversampling factor associated with a vertical antenna polarization and a second DFT oversampling factor associated with a horizontal antenna polarization.

22. The network entity of claim 21, wherein the set of DFT oversampling factor pairs lacks a DFT oversampling pair comprising a zero value for both the first DFT oversampling factor associated with the vertical antenna polarization and the second DFT oversampling factor associated with the horizontal antenna polarization.

23. The network entity of claim 21, wherein the first DFT oversampling factor associated with the vertical antenna polarization and the second DFT oversampling factor associated with the horizontal antenna polarization are indicative of the at least one beam in both a vertical dimension and a horizontal dimension.

24. The network entity of claim 15, wherein the plurality of channel state information-reference signal antenna ports comprise greater than 16 channel state information-reference signal antenna ports, and the one or more processors are individually or collectively further operable to execute the code to cause the network entity to:
obtain an indication of a selection of at least one beam of the set of one or more beams in accordance with a unified codebook associated with the at least two layers of the precoding matrix,
wherein the at least two layers of the precoding matrix comprise two layers, three layers, four layers, or any combination thereof.

25. The network entity of claim 24, wherein the set of one or more beams is based at least in part on a set of respective vertically polarized antenna ports multiplied by respective discrete Fourier transform (DFT) oversampling factors in a vertical dimension and a set of respective horizontally polarized antenna ports multiplied by respective DFT oversampling factors in a horizontal dimension.

26. The network entity of claim 15, wherein the plurality of channel state information-reference signal antenna ports comprise at least 32 channel state information-reference signal antenna ports and the rank indicator comprises three layers or four layers, and a quantity of available beam values for a vertical dimension is adjusted by one half for quantities of vertically polarized antenna ports greater than one.

27. The network entity of claim 26, wherein the quantity of available beam values for the vertical dimension is adjusted by one half relative to the quantity of available beam values for a horizontal dimension.

28. The network entity of claim 15, wherein the plurality of channel state information-reference signal antenna ports comprises a quantity that is greater than 32 channel state information-reference signal antenna ports.

29. A method for wireless communications at a user equipment (UE), comprising:
receiving, from a network entity, a set of channel state information reference signals associated with a plurality of channel state information-reference signal antenna ports;
generating a channel state information report according to a first type of codebook, wherein the channel state information report includes an indication of a set of one or more beams associated with a precoding matrix, and wherein the indication of the set of one or more beams is based at least in part on a rank indicator being greater than at least two layers; and
transmitting the channel state information report to the network entity.

30. A method for wireless communications at a network entity, comprising:
outputting a set of channel state information reference signals via a plurality of channel state information-reference signal antenna ports at the network entity; and
receiving a channel state information report according to a first type of codebook, wherein the channel state information report includes an indication of a set of one or more beams associated with a precoding matrix, and wherein the indication of the set of one or more beams is based at least in part on a rank indicator being greater than at least two layers.
